(19) United States
(12) Patent Application Publication
(10) Pub. No.: US 2026/0030755 A1
(43) Pub. Date: Jan. 29, 2026

(54) RETINAL IMAGE SEGMENTATION VIA SEMI-SUPERVISED LEARNING

(71) Applicants: Hoffmann-La Roche Inc., Little Falls, NJ (US); Genentech, Inc., South San Francisco, CA (US)

(72) Inventors: Thomas Felix ALBRECHT, Basel (CH); Alvaro Gomariz CARRILLO, Zurich (CH); Daniela Ferrara CAVALCANTI, Marlborough, MA (US); Yusuke Alexander KIKUCHI, South San Francisco, CA (US); Yun Yvonna LI, Basel (CH); Huanxiang LU, Préverenges (CH); Andreas MAUNZ, Basel (CH); Orcun GOEKSEL, Uppsala (SE)

(21) Appl. No.: 19/349,706

(22) Filed: Oct. 3, 2025

Related U.S. Application Data
(63) Continuation of application No. PCT/US2024/023475, filed on Apr. 5, 2024.
(60) Provisional application No. 63/494,456, filed on Apr. 5, 2023.

(51) Int. Cl. G06T 7/00; G06T 7/11

(52) U.S. Cl. CPC G06T 7/0012; G06T 7/11; G06T 2207/10101; G06T 2207/20081; G06T 2207/30041

(57) ABSTRACT

Systems and methods for performing automated retinal segmentation. Initial imaging data that is associated with a target domain is received. The initial imaging data captures a retina. An image input for a machine learning model using the initial imaging data is formed. A segmentation output that graphically locates a set of retinal elements with respect to the initial imaging data is generated via the machine learning model. The machine learning model has been trained using a loss function that combines a supervised learning loss and a contrastive learning loss. The machine learning model has been trained using a training dataset that includes labeled imaging data associated with a set of source domains, the set of source domains being different from the target domain.

### CROSS-REFERENCE TO RELATED APPLICATIONS

This application is a continuation of International Application PCT/US2024/023475 filed Apr. 5, 2024, which claims the benefit of the priority date of U.S. Provisional Application 63/494,456, filed Apr. 5, 2023, and entitled “Retinal Image Segmentation via Semi-Supervised Learning,” the disclosures of which are incorporated herein by reference in their entirety.

### TECHNICAL FIELD

This application relates to retinal segmentation used in the diagnosis and/or treatment of retinal diseases (or conditions), and more particularly, to automated segmentation of unlabeled retinal imaging data received from a target imaging device using machine learning-based algorithms trained using retinal imaging data generated by a set of imaging devices that are different from the target imaging device.

### INTRODUCTION

Age-related macular degeneration (AMD) is a leading cause of vision loss in subjects 50 years and older. AMD initially manifests as a dry type of AMD and can progress to a wet type of AMD. For the dry type, small deposits (drusen) form under the macula on the retina, causing the retina to deteriorate in time. For the wet type, which may also be referred to as neovascular AMD (nAMD), abnormal blood vessels originating in the choroid layer of the eye grow into the retina and leak fluid from the blood into the retina. Upon entering the retina, the fluid may distort the vision of a subject immediately, and over time, can damage the retina itself, for example, by causing the loss of photoreceptors in the retina. The fluid can cause the macula to separate from its base, resulting in severe and fast vision loss.

Optical coherence tomography (OCT) can provide a detailed scan of the macula to help detect macular degeneration, diabetic macular edema, and other macular problems much earlier than was possible in the past. To investigate the extent of the deterioration in a retina with AMD, OCT images (e.g., time domain optical coherence tomography (TD-OCT) or spectral domain optical coherence tomography (SD-OCT) images) of the retina may be obtained and used for identifying features that may be associated with varying degenerative levels of AMD. SD-OCT is an imaging technique in which light is directed at the retina at various optical frequencies and in which the reflected light is collected to capture two-dimensional or three-dimensional, high-resolution, cross-sectional images of the retina via interferometric signals detected as a function of frequencies. Different features that are captured in the SD-OCT images can be identified via retinal segmentation and used in determining the severity of the AMD, which may help guide the diagnosis and/or treatment of the AMD. However, currently available techniques used in extracting, understanding, and/or interpreting such features may be plagued with tediousness and/or prone to error. Accordingly, the cumbersome nature of the AMD investigation process may be a limiting factor in the diagnosis and/or treatment of the AMD. Thus, it may be desirable to have one or more methods and/or systems that recognize and take into account these issues.

### SUMMARY

In one or more embodiments, a method for segmentation of a retina is provided. Initial imaging data that is associated with a target domain is received. The initial imaging data captures a retina. An image input for a machine learning model is formed using the initial imaging data. A segmentation output that graphically locates a set of retinal elements with respect to the initial imaging data is generated via the machine learning model. The machine learning model has been trained using a loss function that combines a supervised learning loss and a contrastive learning loss. The machine learning model has been trained using a training dataset that includes labeled imaging data associated with a set of source domains, the set of source domains being different from the target domain.

In one or more embodiments, a method for training a machine learning model is provided. A training dataset that includes labeled imaging data associated with a set of source domains is formed. A machine learning model is trained to perform automated segmentation using the training dataset and a loss function that combines a supervised learning loss and a contrastive learning loss. The training machine learning model is capable of processing imaging data associated with a target domain to generate a segmentation output with a desired level of performance. The target domain is different from the set of source domains. The training dataset excludes any labeled imaging data associated with the target domain.

In one or more embodiments, a system comprises one or more data processors and a non-transitory computer readable storage medium containing instructions which, when executed on the one or more data processors, cause the one or more data processors to receive initial imaging data that is associated with a target domain, wherein the initial imaging data captures a retina; form image input for a machine learning model using the initial imaging data; and generate, via the machine learning model, a segmentation output that graphically locates a set of retinal elements with respect to the initial imaging data. The machine learning model has been trained using a loss function that combines a supervised learning loss and a contrastive learning loss. the machine learning model has been trained using a training dataset that includes labeled imaging data associated with a set of source domains, the set of source domains being different from the target domain.

In one or more embodiments, a system for training a machine learning model to perform automated segmentation comprises one or more data processors and a non-transitory computer readable storage medium containing instructions which, when executed on the one or more data processors, cause the one or more data processors to form a training dataset that includes labeled imaging data associated with a set of source domains; and train the machine learning model to perform the automated segmentation using the training dataset and a loss function that combines a supervised learning loss and a contrastive learning loss. The trained machine learning model is capable of processing imaging data associated with a target domain to generate a segmentation output with a desired level of performance. The target domain is different from the set of source domains. The training dataset excludes any labeled imaging data associated with the target domain.

In one or more embodiments, a system comprises one or more data processors and a non-transitory computer readable storage medium containing instructions which, when executed on the one or more data processors, cause the one or more data processors to perform part or all of one or more methods disclosed herein or a portion thereof.

In one or more embodiments, a computer-program product tangibly embodied in a non-transitory machine-readable storage medium, including instructions configured to cause one or more data processors to perform part or all of one or more methods disclosed herein or a portion thereof.

### BRIEF DESCRIPTION OF THE DRAWINGS

For a more complete understanding of the principles disclosed herein, and the advantages thereof, reference is now made to the following descriptions taken in conjunction with the accompanying drawings, in which:

FIG. 1 is a block diagram of an image processing system, in accordance with various embodiments.

FIG. 2 is a block diagram of a joint learning model of a retinal segmentation system, in accordance with various embodiments.

FIG. 3 is an illustration of example images associated with a set of domains, in accordance with various embodiments.

FIG. 4 is a schematic diagram of an example of a training framework that may be used to train a joint learning model, in accordance with various embodiments.

FIG. 5 is a schematic diagram of an example of a training framework that may be used to train a joint learning model, in accordance with various embodiments.

FIG. 6 is a flowchart of a process for analyzing imaging data of a retina of a subject, in accordance with various embodiments.

FIG. 7 is a flowchart of a process for training a machine learning model to perform automated segmentation, in accordance with various embodiments.

FIG. 8 is a schematic diagram of a model architecture for a machine learning model, in accordance with various embodiments.

FIGS. 9A-9D are tables showing metrics for segmentation performance in accordance with various embodiments.

FIG. 10 is a block diagram of a computer system in accordance with various embodiments.

It is to be understood that the figures are not necessarily drawn to scale, nor are the objects in the figures necessarily drawn to scale in relationship to one another. The figures are depictions that are intended to bring clarity and understanding to various embodiments of apparatuses, systems, and methods disclosed herein. Wherever possible, the same reference numbers will be used throughout the drawings to refer to the same or like parts. Moreover, it should be appreciated that the drawings are not intended to limit the scope of the present teachings in any way.

### DETAILED DESCRIPTION

### I. Overview

Various types of retinal diseases (or conditions) may be detected, diagnosed, and/or treated using a detailed scan of the retina. As one example, neovascular age-related macular degeneration (nAMD) may be detected, diagnosed, and/or treated using a detailed scan of the retina in the macula region. The embodiments described herein provide an improved technique for automated retinal segmentation of retinal images (e.g., retinal scans) that is more accurate and more reliable than existing methods for processing retinal images. More accurate and more reliable retinal segmentation may help ensure more accurate and thorough diagnostic and/or treatment solutions for patients with retinal diseases such as, for example, but not limited to, nAMD.

Retinal segmentation includes the detection and identification of one or more retinal (e.g., retina-associated) elements in a retinal image. A retinal element may be comprised of at least one of a retinal layer element or a retinal pathological element. Detection and identification of one or more retinal layer elements may be referred to as layer element (or retinal layer element) segmentation. Detection and identification of one or more retinal pathological elements may be referred to as pathological element (or retinal pathological element) segmentation.

A retinal layer element may be, for example, a retinal layer or a boundary associated with a retinal layer. Examples of retinal layers include, but are not limited to, an internal limiting membrane (ILM) layer, a retinal nerve fiber layer, a ganglion cell layer, an inner plexiform layer, an inner nuclear layer, an outer plexiform layer, an outer nuclear layer, an external limiting membrane (ELM) layer, a photoreceptor layer(s), a retinal pigment epithelial (RPE) layer, a layer of RPE detachment, a Bruch's membrane (BM) layer, a choriocapillaris layer, a choroidal stroma layer, an ellipsoid zone (EZ), and other types of retinal layer. In some cases, a retinal layer may be comprised of one or more layers. As one example, a retinal layer may be an outer plexiform layer-Henle fiber layer (OPL-HFL). A boundary associated with a retinal layer may be, for example, an inner boundary of the retinal layer, an outer boundary of the retinal layer, a boundary associated with a pathological feature of the retinal layer (e.g., an inner or outer boundary of detachment of the retinal layer), or some other type of boundary. For example, a boundary may be an inner boundary of an RPE (IB-RPE) detachment layer, an outer boundary of the RPE (OB-RPE) detachment layer, or another type of boundary.

A retinal pathological element may include, for example, fluid (e.g., a fluid pocket), cells, solid material, or a combination thereof that evidences a retinal pathology (e.g., disease or condition such as AMD or diabetic macular edema). For example, the presence of certain retinal fluids may be a sign of nAMD. Examples of retinal pathological elements include, but are not limited to, intraretinal fluid (IRF), subretinal fluid (SRF), fluid associated with pigment epithelial detachment (PED), hyperreflective material (HRM), subretinal hyperreflective material (SHRM), intraretinal hyperreflective material (IHRM), hyperreflective foci (HRF), a retinal fluid pocket, drusen, a development of fibrosis, and a disruption. In some cases, a retinal pathological element may be a disruption (e.g., discontinuity, delamination, loss, etc.) of a retinal layer or retinal zone. For example, the disruption may be of the ellipsoid zone, of the ELM, of the RPE, or of another layer or zone. The disruption may represent damage to or loss of cells (e.g., photoreceptors) in the area of the disruption. In some examples, a retinal pathological element may be clear IRF, turbid IRF, clear SRF, turbid SRF, some other type of clear retinal fluid, some other type of turbid retinal fluid, or a combination thereof.

For example, currently available techniques used in extracting, understanding, and/or interpreting such features may be plagued with tediousness, may be prone to error, and/or may require large amounts of manually-annotated data (“labeled imaging data”) for training. But in many instance, large amounts of manually-annotated data may be unavailable. Further, obtaining manually-annotated data can be costly and at times infeasible given the size of a given imaging dataset. Further, such labeling may need to be conducted for each new disease or imaging device used to generate a given imaging dataset. As such, domain-shift (i.e., shifting between imaging data generated from different eye diseases and/or different imaging devices) is a significant consideration when training machine learning models to automatically perform retinal segmentation.

For example, existing methodologies and systems that use machine learning models for performing retinal segmentation may have difficulty accurately performing retinal segmentation for OCT imaging data that differs from the OCT imaging data on which the machine learning models were trained. For example, a retinal segmentation machine learning model may have difficulty accurately performing automated retinal segmentation for OCT imaging generated by a first imaging device where the machine learning model was trained on imaging data generated by a second imaging device that is different from the first imaging device. In other words, the machine learning model may have difficulty adapting to this different domain of imaging data.

Thus, the embodiments described herein provide methods and systems for performing automated retinal segmentation in a manner that can utilize labeled imaging data associated with one domain (e.g., corresponding to a particular type of imaging device or retinal disease) as well as, optionally, unlabeled imaging data associated with a different type of domain to be able to later perform segmentation for that different type of domain with a desired level of accuracy and reliability. The embodiments described herein may be able to account for domain shift.

For example, the embodiments described herein provide methodologies and systems for performing automated retinal segmentation of retinal elements in a manner that improves the accuracy of quality of retinal segmentation for imaging data (e.g., OCT imaging data) that differs (e.g., was generated by a different type of device) from the labeled imaging data (e.g., labeled training OCT imaging data) used to train the machine learning model.

The embodiments described herein provide a method for training a machine learning model that allows the machine learning model to quickly adapt to different domains of imaging data (e.g., imaging data generated by a different device than the device used to generate the labeled training data or capturing a different type of retinal disease or condition). In some embodiments, both labeled imaging data and unlabeled imaging data are used to train the machine learning model. The labeled imaging data may be, for example, OCT imaging data generated by one imaging device that was manually annotated by a human grader. The unlabeled imaging data may be, for example, OCT imaging data generated by a different imaging device that has not been annotated by a human grader.

The embodiments described herein use a semi-supervised framework for joint training with substantially simultaneous contrastive loss learning and supervised learning. This type of machine learning model may be referred to as a joint learning model. Its framework is versatile and designed to perform automated segmentation of volumetric images (e.g., OCT volumes) across different domains of imaging data. Training may include using imaging data (labeled or unlabeled) for a first domain and, optionally, unlabeled imaging data for a second domain where the joint learning model is to be used for segmentation on the second domain. No labeled imaging data associated with the second domain is used for training. The joint learning model described these embodiments overcomes the limitations associated with domain shifts in the unsupervised domain adaptation setting. Further, large amounts of unlabeled imaging data are not needed in order for successful training that leads to good segmentation performance. Further, the embodiments described herein use contrastive learning that is implemented via unique techniques for aggregation of layers without losing spatial context and for pair generations for learning.

Recognizing and taking into account the importance and utility of a methodology and system that can provide the improvements described above, the specification describes various embodiments for performing automated retinal segmentation, which may include layer element segmentation and/or pathological element segmentation, using a ML-based algorithm. The embodiments described herein enable more accurate and more reliable retinal segmentation across domains, which may improve the accuracy and reliability of any detection, diagnosis, and/or treatment methodologies that rely on the results of this retinal segmentation.

### II. Example System for Machine Learning (ML)-Based Retinal Segmentation

### II.A. General Overview

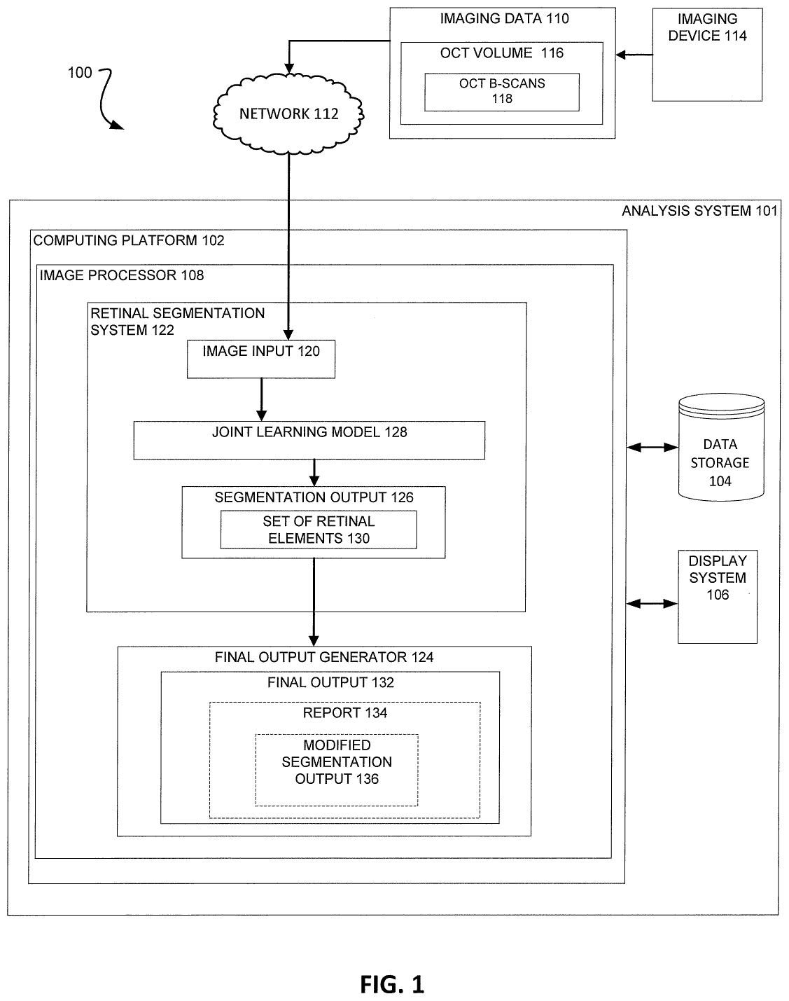

FIG. 1 is a block diagram of an image processing system 100, in accordance with various embodiments. The image processing system 100 is used for automatically performing retinal segmentation of retinal images to aid in the evaluation, detection, diagnosis, and/or treatment of patients with one or more retinal diseases (or conditions) such as, for example, but not limited to, nAMD, DME, and diabetic retinopathy.

Image processing system 100 includes analysis system 101. Analysis system 101 may be implemented using hardware, software, firmware, or a combination thereof. In one or more embodiments, analysis system 101 may include a computing platform 102, a data storage 104 (e.g., database, server, storage module, cloud storage, etc.), and a display system 106. Computing platform 102 may take various forms. In one or more embodiments, computing platform 102 includes a single computer (or computer system) or multiple computers in communication with each other. In other examples, computing platform 102 takes the form of a cloud computing platform, a mobile computing platform (e.g., laptop, a smartphone, a tablet, etc.), another processor-based device (e.g., a workstation or desktop computer) or a wearable computing device (e.g., a smartwatch), and/or a combination thereof.

Data storage 104 and display system 106 are each in communication with computing platform 102. In some examples, data storage 104, display system 106, or both may be considered part of or otherwise integrated with computing platform 102. Thus, in some examples, computing platform 102, data storage 104, and display system 106 may be separate components in communication with each other, but in other examples, some combination of these components may be integrated together.

Analysis system 101 includes image processor 108 that receives imaging data 110 for processing. Image processor 108 may be implemented using hardware, firmware, software, or a combination thereof. In one or more embodiments, image processor 108 may be implemented within computing platform 102.

In one or more embodiments, image processor 108 receives imaging data 110 over network 112 for processing. Network 112 may be implemented using a single network or multiple networks in combination. Network 112 may be implemented using any number of wired communications links, wireless communications links, optical communications links, or combination thereof. For example, in various embodiments, network 112 may include the Internet or one or more intranets, landline networks, wireless networks, and/or other appropriate types of networks. In another example, the network 112 may comprise a wireless telecommunications network (e.g., cellular phone network) adapted to communicate with other communication networks, such as the Internet. In some cases, network 112 includes at least one of a local area network (LAN), a virtual local area network (VLAN), a wide area network (WAN), a public land mobile network (PLMN), the Internet, or another type of network.

In one or more embodiments, image processor 108 receives imaging data 110 over network 112 from one or more imaging devices (e.g., imaging device 114). In this manner, image processor 108 and imaging device 114 may be in communication with each other. In some cases, at least a portion of (e.g., a module of) image processor 108 is implemented within imaging device 114.

In some cases, imaging device 114 may generate imaging data 110 and send imaging data 110 to image processor 108 in response to a request or event (e.g., a request received from imaging device 114, a request from a scheduler internal to imaging device 114, or some other type of request). In some cases, imaging device 114 includes hardware, software, and/or firmware for processing imaging data 110 prior to sending imaging data 110 to image processor 108 within analysis system 101.

In one or more embodiments, imaging device 114 includes an optical coherence tomography (OCT) system (e.g., OCT scanner or machine) that is configured to generate imaging data 110 for the tissue of a patient. The imaging device 114 may be, for example, a swept-source scanner, a spectral domain scanner, or other types of scanners. In some instances, imaging device 114 can be a large tabletop configuration used in clinical settings, a portable or handheld dedicated system, or a “smart” OCT system incorporated into user personal devices such as smartphones.

Imaging data 110 may include, for example, any number of three-dimensional, two-dimensional, or one-dimensional spectral domain (SD) OCT or TD-OCT images. A two-dimensional OCT image may take the form of, for example, without limitation, an OCT B-scan. A three-dimensional OCT image may be referred to as an OCT volume. An OCT volume may itself be comprised of multiple OCT B-scans. Imaging data 110 may include OCT volume 116, which may itself include OCT B-scans 118. OCT B-scans 118 may include, for example, without limitation, 10s, 100s, 1000s, 10,000s, or some other number of OCT B-scans. An OCT B-scan may also be referred to as an OCT slice image or a cross-sectional OCT image.

According to some embodiments, imaging device 114 may be used to generate imaging data 110 for a retina of a patient. In some embodiments, the retina is a healthy retina. In other embodiments, the retina is one that has been diagnosed with or is suspected of having a retinal disease. For example, the diagnosis may be one of age-related macular degeneration (AMD), neovascular age-related macular degeneration (nAMD), DME, or some other type of retinal disease. In one or more embodiments, the retina captured by OCT volume 116 may be one that has been diagnosed (e.g., by a computer system, program, or human) as having a retinal disease. In one or more embodiments, image processor 108 forms image input 120 for processing. For example, OCT volume 116 may be preprocessed using a set of preprocessing operations to form the image input 120. The set of preprocessing operations may include, for example, without limitation, at least one of a normalization operation, a scaling operation, a resizing operation, a horizontal flipping operation, a vertical flipping operation, a cropping operation, a rotation operation, a noise filtering operation, or some other type of preprocessing operation. A normalization operation may be performed to normalize the coordinates of the coordinate system for OCT volume 116. In some cases, pixel values may be normalized (e.g., normalized to values between 0-1). A scaling operation may include, for example, scaling a coordinate system associated with OCT volume 116. A resizing operation may include changing a size of each of plurality of OCT B-scans 118. A preprocessing operation of the set of preprocessing operations may be performed on one or more of plurality of OCT B-scans 118 of the OCT volume 116. In some embodiments, image input 120 may include OCT imaging data generated by imaging device 114 without any preprocessing operations performed on the OCT imaging data. For example, image input 120 may include OCT volume 116 and/or plurality of OCT B-scans 118 without any preprocessing.

In some embodiments, image input 120 may additionally include one or more color fundus (CF) images, one or more fundus autofluorescence (FAF) images, one or more fluorescein angiography (FA) images, one or more other types of OCT images (e.g., OCT-A images), one or more other types of retinal images, or a combination thereof. In this manner, imaging data 110 may include multi-modal image input. Using multi-modal image input may increase the accuracy of the retinal segmentation. For example, at least a portion of image input 120 may be received from another imaging device (or system) or computing platform, retrieved from a database, uploaded from a cloud computing platform, received via an electronic message (e.g., email), received from a data storage device, retrieved from a data structure, and/or received in some other manner. In one or more embodiments, at least a portion of image input 120 is retrieved from data storage 104. In some cases, imaging data 110 generated by imaging device 114 may be stored in data storage 104 for future processing by image processor 108.

Image processor 108 may include, for example, retinal segmentation system 122 and final output generator 124, each of which may be implemented using hardware, software, firmware, or a combination thereof. Retinal segmentation system 122 may use image input 120 to generate segmentation output 126. For example, retinal segmentation system 122 may include a model for performing automated retinal segmentation of image input 120 to generate segmentation output 126. In one or more embodiments, segmentation output 126 identifies various retinal elements captured in the OCT imaging data received as image input 120. These retinal elements may include elements such as those described above in Section I (Overview). For example, these retinal elements may include retinal layer elements.

In one or more embodiments, retinal segmentation system 122 uses a machine learning model, which may be joint learning model 128, to perform automated segmentation and to generate segmentation output 126. Joint learning model 128 may be implemented in different ways and may itself be a combination or integration of multiple models. In one or more embodiments, model takes the form of a deep learning system such as, but not limited to, neural network system. The neural network system may include any number of or combination of neural networks. In one or more embodiments, joint learning model 128 takes the form of a convolutional neural network (CNN) system that includes one or more convolutional neural networks. For example, the CNN may include a plurality of neural networks, each of which may itself be a convolutional neural network. In one or more embodiments, joint learning model 128 includes one or more UNets, one or more convolutional layers, oner or more other types of layers or functions (e.g., pooling layers, sigmoid activation function, etc.), or a combination thereof.

Joint learning model 128 may be a model that uses supervised learning and contrastive learning during training such that joint learning model 128 can be applied to perform automated segmentation. For example, the loss function used in training joint learning model 128 may combine both a supervised learning loss and a contrastive learning loss (which may be also referred to as contrastive loss). Examples of how joint learning model 128 may be implemented, trained, evaluated, and applied are described in greater detail in Section II.B. Further, additional details with respect to how joint learning model 128 may be implemented, trained, evaluated, and applied are further provided in Section IV with respect to a multi-part study that was performed to build various trained models, each being one example of an implementation for joint learning model 128.

Segmentation output 126 may graphically locate a set of retinal elements 130 with respect to image input 120. In one or more embodiments, set of retinal elements 130 may include a set of retinal pathological elements, a set of retinal layer elements, or both with respect to the OCT imaging data. In one or more embodiments, segmentation output 126 includes an image or volume that graphically identifies retinal elements that include at least one of intraretinal fluid (IRF), subretinal fluid (SRF), fluid associated with pigment epithelial detachment (PED), hyperreflective material (HRM), subretinal hyperreflective material (SHRM), intraretinal hyperreflective material (IHRM), hyperreflective foci (HRF), a retinal fluid pocket, or a disruption. In some embodiments, one or more of the retinal elements may be associated with a retinal layer selected from a group consisting of an internal limiting membrane (ILM) layer, an external limiting membrane (ELM) layer, an outer plexiform layer-Henle fiber layer (OPL-HFL), a retinal pigment epithelial (RPE) layer, a layer of RPE detachment, a Bruch's membrane (BM) layer, and an ellipsoid zone (EZ).

Segmentation output 126 may include a set of graphical features that locate and identify set of retinal elements 130. This set of graphical features may include, for example, without limitation, at least one of a color indicator, a shape indicator, a pattern indicator, a shading indicator, a line, a curve, a marker, a label, a tag, or text that graphically locates the set of retinal elements.

Segmentation output 126 may take the form of a segmented volume that includes a plurality of segmented 2D images (e.g., 2D slices). Each of the plurality of segmented 2D images may graphically locate at least a portion of a retinal element in 2D such that the segmented volume graphically locates the retinal element in 3D (e.g., forms a 3D representation of the retinal element). Thus, the segmented volume may include a set of 3D segments, each of which represents or otherwise identifies/corresponds to a retinal element captured in imaging data 110.

As previously discussed, image processor 108 may further include final output generator 124. Final output generator 124 may receive segmentation output 126 for processing to form final output 132. Final output 132 may take various forms.

In one or more embodiments, final output generator 124 may generate final output 132 in the form of a report 134 that includes any one or more of the above-identified outputs and/or other information. For example, report 134 may include segmentation output 126, modified segmentation output 136, one or more other types of information, or a combination thereof. Modified segmentation output 136 may include, for example, one or more annotations in the form of text labels, graphical markings, highlighting, circling, etc.

In one or more embodiments, report 134 may include an indication (or prediction) of a prognosis for the subject with respect to a retinal disease that is generated based on segmentation output 126, modified segmentation output 136, or both. The indication may include, for example, without limitation, a prediction of disease progression, such as, but not limited to, a predicted disease growth rate, a predicted future measured area for an area of the retina affected by the retinal diseases, a prediction of treatment response, and/or a prediction of disease burden.

In one or more embodiments, analysis system 101 stores imaging data 110 obtained from imaging device 114 or a portion thereof, image input 110 or a portion thereof, segmentation output 126 or a portion thereof, final output 132 or a portion thereof, other data generated during the processing of imaging data 110, or a combination thereof in data storage 104. In some embodiments, the portion of data storage 104 storing such information may be configured to comply with the security requirements of the Health Insurance Portability and Accountability (HIPAA) that mandate certain security procedures when handling patient data (e.g., such as OCT images of tissues of patients) (i.e., the data storage 104 may be HIPAA-compliant). For instance, the information being stored may be encrypted and anonymized. For example, OCT volume 116 may be encrypted as well as processed to remove and/or obfuscate personally identifying information of the subjects from which OCT volume 116 was obtained. In some instances, the communications link between imaging device 114 and analysis system 101 that utilizes network 112 may also be HIPAA-compliant. For example, at least a portion of network 112 may be a virtual private network (VPN) that is end-to-end encrypted and configured to anonymize personally identifying information data transmitted therein.

Image processing system 100 may be implemented using any number or combination of servers and/or software components that operate to perform various processes related to the capturing and processing of imaging data of retinas. Examples of servers may include, for example, stand-alone and enterprise-class servers. In one or more embodiments, image processing system 100 may be operated and/or maintained by one or more different entities.

In some embodiments, imaging device 114 may be maintained by an entity that is tasked with obtaining imaging data 110 for tissue samples of subjects for the purposes of disease screening, diagnosis, disease monitoring, disease treatment, research, clinical trial management, or a combination thereof. For example, the entity may be a health care provider (e.g., ophthalmology healthcare provider) that seeks to obtain imaging data 110 for retinas of subjects for use in diagnosing retinal diseases and/or other types of eye conditions. As another example, the entity may be an administrator of a clinical trial that is tasked with collecting imaging data 110 for retinas of subjects to monitor retinal changes over the course of a disease, monitor treatment response, or both. Analysis system 101 may be maintained by a same or different entity (or entities) as imaging device 114. For example, analysis system 101 may be maintained by an entity that is tasked with identifying or discovering biomarkers of retinal diseases from OCT images.

Analysis system 101 described herein is a system that is specially configured for automated retinal segmentation via customized training and development of retinal segmentation system 122. For example, joint learning model 128 of retinal segmentation system 122 of analysis system 101 may be trained according to a customized joint learning framework that allows joint learning model 128 to be applied to process imaging data 110 generated by imaging device 114 and generate segmentation output 126 with a desired level of accuracy. One example of an implementation for this customized joint learning framework is described in further detail in Section II.B below.

### II.B. Example Framework for Training Joint Learning Model

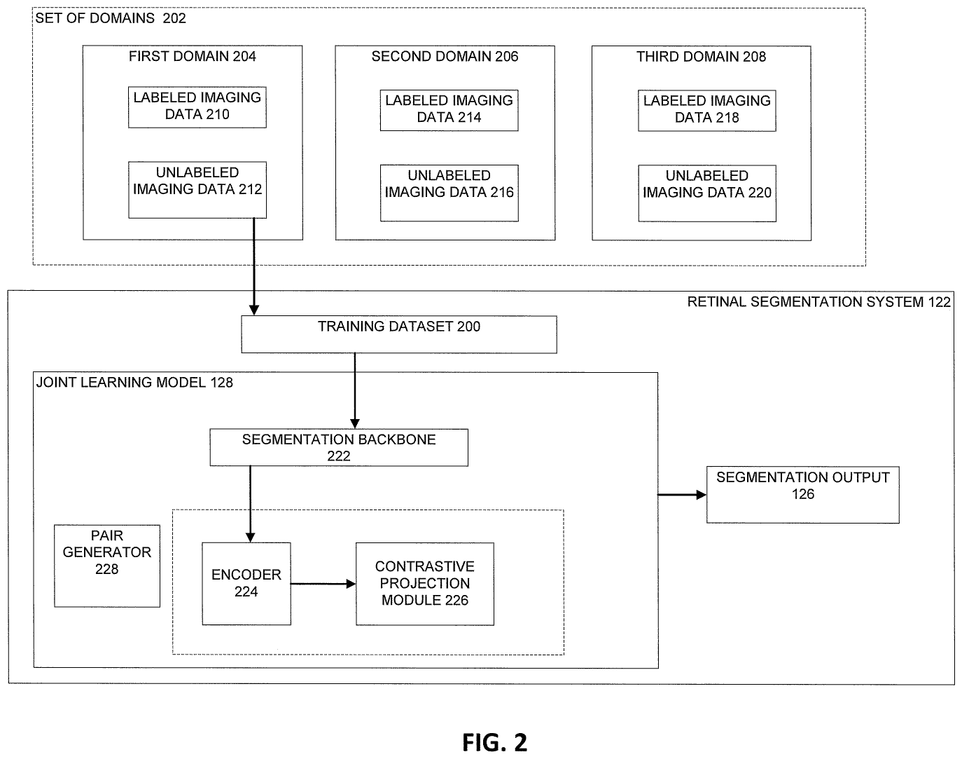

FIG. 2 is a block diagram of the joint learning model 128 of retinal segmentation system 122 from FIG. 1, described in further detail in accordance with one or more embodiments. Training joint learning model 128 of retinal segmentation system 122 involves both supervised learning and contrastive learning. In the image segmentation context, supervised learning involves using labeled imaging datasets (e.g., manually annotated OCT volumes) that serve as ground truth data with the aim of generating a segmentation output that is equal or similar to the ground truth data. Contrastive learning aims to minimize or reduce distances between “positive” pairs of imaging data (e.g., an anchor image and a similar or “positive” image) and maximize or increase the distances between “negative” pairs of imaging data (e.g., an anchor image and a different or “negative” image).

Joint learning model 128 may be trained using training dataset 200. Training dataset 200 may be formed using imaging data associated with one or more selected domains from a set of domains 202.

As previously discussed, a “domain’ may refer to data that is associated with a specific subject area or problem space for which a machine learning model is trained and applied. A “domain” may be all the values that make sense, given the context (e.g., specific subject area or problem space), as going into a function. A domain may refer to image content (e.g., retinal disease or condition) or image appearance (e.g., based on imaging device used to capture image). For example, a “domain” may refer to data that is captured by one type of imaging device such that data generated by a first type of imaging device can be considered of a “first domain” and data generated by a second type of imaging device can be considered of a “second domain.” The “type” of imaging device may refer to a brand type, model type, or configuration type where two imaging devices of the same brand/model type can still correspond to different domains because the parameters of these devices have been configured differently. In other examples, a “domain” may refer to imaging data that was captured in association with a particular type of ophthalmological (e.g., retinal) disease or condition, a particular stage or phase of a retinal disease or condition, a degree of disease or condition severity, a degree of disease burden, or a combination thereof. As one example, imaging data capturing retinas diagnosed with nAMD may be considered to be of a different domain than imaging data capturing retinas diagnosed with DME.

Set of domains 202 may include one or more domains. Each domain may include labeled imaging data (e.g., manually annotated OCT volumes with annotations identifying one or more retinal elements of interest) and optionally, unlabeled imaging data (e.g., OCT volumes without any annotations). For example, set of domains 202 may include first domain 204, second domain 206, and third domain 208.

First domain 204 may include labeled imaging data 210 (e.g., OCT images that are manually annotated such that they are “labeled”), unlabeled imaging data 212, or both. Second domain 206 may include labeled imaging data 214, unlabeled imaging data 216, or both. Third domain 208 may include labeled imaging data 218, unlabeled imaging data 220, or both. Training dataset 200 may be formed using different combinations of the labeled and unlabeled imaging data associated with set of domains 202. Labeled imaging data may include imaging data that may be used as ground truth data in training.

In one or more embodiments, first domain 204 includes data acquired by a different type of imaging device (e.g., different OCT scanner) than what was used to acquire data associated with second domain 204. In one or more embodiments, first domain 204 and third domain 208 include data acquired by a same type of imaging device but capture retinas associated with different retinal diseases or conditions. As one example, first domain 204 may include imaging data for nAMD subjects, while third domain 208 may include imaging data for DME subjects.

Joint learning model 128 may be trained using training dataset 200 in different ways. For example, joint learning model 128 may include segmentation backbone 222, encoder 224, contrastive projection module 226, and pair generator 228. Encoder 224 and contrastive projection module 226 are used for computing loss and semi-supervised learning.

Segmentation backbone 222 may be implemented using one or more convolutional neural networks that can be used to process an image x to produce a segmentation map that approximates ground truth segmentation (e.g., manually annotated) y. Accordingly, segmentation backbone 220 may also be referred to as a retinal element extraction module. Segmentation may be performed at a 2D image level (e.g., OCT B-scan). The segmentation map generated for an OCT B-scan identifies one or more retinal elements of interest (e.g., one or more retinal fluid elements).

Segmentation backbone 222 may be implemented using, for example, a UNet (or U-Net) based architecture that can be trained via supervised learning. Specifically, the training of segmentation backbone 222 aims to minimize a supervised loss (Lₛᵤₚ). In some instances, this supervised loss may be the logarithmic Dice loss of labeled imaging data (e.g., labeled imaging data) in a source domain, D^{s}. A “source domain” may be the domain of data from which labeled imaging data is used in the training of joint learning model 128. For example, at least a portion of labeled imaging data 210, at least a portion of labeled imaging data 214, at least a portion of labeled imaging data 218, or a combination thereof may be selected to be the labeled imaging data used in training.

In one or more embodiments encoder 224 and contrastive projection module 226 allow for semi-supervised training that can be performed using unlabeled imaging data. In some cases, the unlabeled imaging data is associated with a source domain. In other cases, the unlabeled imaging data is associated with a target domain. The “target” domain may be the domain of data from which no labeled imaging data (and optionally, no unlabeled imaging data) is used in the training of joint learning model 128.

For example, imaging data (labeled and optionally, unlabeled) that is associated with one or more “source” domains may be used for training such that the joint learning model 128, once trained, can be applied to perform segmentation of imaging data associated with a “target” domain. In some cases, the training includes using unlabeled imaging data from the target domain. In other cases, the training does not include using unlabeled imaging data from the target domain. Where no imaging data from the target domain is used for training, the application of the joint learning model 128 to the imaging data from the target domain may be referred to as zero-shot adaptation. Where unlabeled imaging data from the target domain is used in training, the application of the joint learning model 128 to the imaging data from the target domain may be referred to as unsupervised domain adaptation.

Encoder 224 may be implemented using a UNet encoder in order to learn features h=E(x) and to adapt learned features h to the segmentation task. Encoder 224 is used for self-supervised learning. Encoder 224 may be followed by a subsequent module for contrastive learning, such as, for example, contrastive projection module 226.

Contrastive projection module 226 (which may be also referred to as a contrastive projection head) is used to map the features h to vector projections z=C(h) with a contrastive loss (L_{con}) then being applied. For example, contrastive projection module 226 may be implemented using an aggregation function ρ^{agg} that aggregates the features h learned by encoder 224 to form a vector that is processed (e.g., by a multilayer perceptron ρ^{MLP}) to create a projection z. In one or more embodiments, contrastive projection module 226 uses a projection C_{ch} that is a convolutional layer that learns how to aggregate layers in order to preserve spatial context to leverage segmentation information. In this manner, contrastive projection module 226 uses channel-wise aggregation that may result in improved performance as compared to using a global pooling operation for aggregation that may make it challenging to preserve spatial context.

The contrastive loss function (L_{con}) seeks to minimize the distance between augmented versions of a same image and maximize the distance between different images. The contrastive loss function may be implemented in different ways using (1) “positive” pairs or (2) both “positive” pairs and “negative” pairs. A “positive” pair is one that includes an anchor image (e.g., a selected OCT B-scan or slice) and a similar image (e.g., a similar version of the anchor image such as an augmented version of the OCT B-scan). A “negative” pair is one that includes the anchor image and a different image (e.g., different OCT B-scan than selected for the anchor).

In one or more embodiments, retinal segmentation system 122 includes pair generator 228 that can be used to generate pairs for contrastive learning. Pair generator 228 may generate pairs using image augmentation, a slice-based pairing, or a combination of both. For example, for augmentation-based pair generation, pair generator 228 may select labeled (and optionally, unlabeled) OCT B-scans (slices) associated with the source domain and optionally, unlabeled OCT B-scans (slices) associated with the target domain. The selected OCT B-scans may then be augmented to create augmented versions of the OCT B-scans. A “pair” may therefore include a selected OCT B-scan and an augmented version of the selected OCT B-scan. The augmentation may include, for example, without limitation, horizontally flipping the image, horizontal and/or vertical translation, zooming in or out, color distortion (e.g., adjusting brightness, adjusting jittering, transforming grayscale image to RGB color space and then back to grayscale), or a combination thereof.

For slice-based pairing, pair generator 228 may select two slices that are close to each other within the OCT volume as being a “positive” pair, while two slices that are far apart from each other within the OCT volume may be considered a “negative” pair. For example, pair generator 228 may select a first OCT B-scan that has an index

$${b}_{i}^{′}$$

as the first image of the pair and a second OCT B-scan that has a different index of approximately (e.g., rounded value of) ϕ (

$${b}_{i}^{′} ,$$

σ), where ϕ is a Gaussian distribution centered on index

$${b}_{i}^{′} ,$$

with standard deviation of σ as a hyperparameter. In other embodiments, a threshold may be used for forming positive pairs and negative pairs. For example, OCT B-scans that are within a certain [[not sure if you're still going into detail here]]

These two pairing strategies (i.e., augmentation and slice-based selection) may be combined. For example, pair generator 228 may build a pair by first selecting OCT B-scans using the slice-based strategy described above and may then augment one or both of the selected OCT B-scans. This type of pair generation may be referred to as a combination pairing strategy.

Training joint learning model 128 to have a framework that includes segmentation backbone 222, encoder 224, and contrastive projection module 226 includes combining the supervised loss (Lₛᵤₚ) with the contrastive loss (L_{con}) to form a total loss, L. Examples of training and evaluating different types of joint learning model 128 are described in Section IV below with respect to a study that compares the performance of these models with other trained models.

Joint learning model 128 is trained such that after training, joint learning model 128 can be used to perform automated segmentation of imaging data associated with a target domain with a desired level of accuracy and generate segmentation output 126, even where the data used to train joint learning model 128 includes, in addition to imaging data (labeled and optionally, unlabeled) from the set of source domains, (1) only unlabeled imaging data associated with the target domain (and no labeled imaging data associated with the target domain) or (2) no imaging data (labeled or unlabeled) associated with the target domain. Further, joint learning model 128 may perform well even where only a relatively small amount of unlabeled imaging data associated with the target domain is used. Still further, with the framework described herein, joint learning model 128 may be configured in such a manner that any number of labeled images (e.g., OCT B-scans) can be accommodated for training, requiring only at least one labeled image for training. For example, joint learning model 128 may be capable of performing with a desired level of performance (e.g., accuracy) using at least one labeled image (e.g., OCT B-scan) associated with a source domain and any number of unlabeled images associated with either the source domain or the target domain.

Training joint learning model 128 using the combination pairing strategy (e.g., a combined slice-based selection and augmentation strategy) and channel-wise aggregation may provide improved performance as compared to other techniques. In some cases, using the augmentation-based pairing strategy with channel-wise aggregation provides improved performance when considering both the source domain and target domain. Using channel-wise aggregation as compared to a global pooling operation for aggregation may add approximately 0.01 to 0.05% parameters to joint learning model 128, indicating very little burden or expense with respect to computational resources. Further, using augmentation-based pairing only without adding slice-based pairing may simplify pair generation without sacrificing performance more than desired.

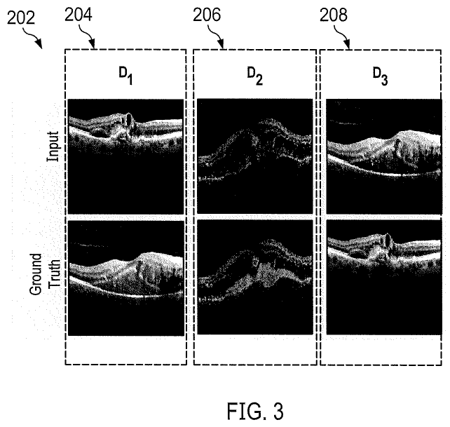

FIG. 3 is an illustration of example images associated with set of domains 202 in FIG. 2 in accordance with one or more embodiments. Each of first domain 204, second domain 206, and third domain 208 may include, for example, OCT volumes, each OCT volume being comprised of a plurality of OCT images (e.g., OCT B-scans). In FIG. 3, examples of these OCT B-scans are shown. Each of first domain 204, second domain 206, and third domain 208 may include an OCT B-scan and a labeled version (e.g., for use as ground truth) of that OCT B-scan. The labeled version may be a manually annotated version of the OCT B-scan (e.g., manually annotated by a human grader). In other embodiments, at least one domain may not include labeled imaging data.

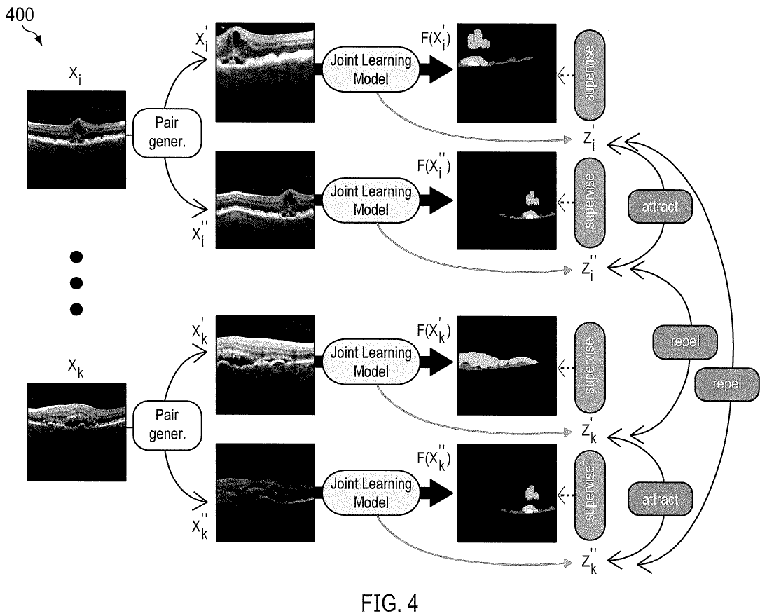

FIG. 4 is a schematic diagram of one example of a training framework 400 that may be used to train joint learning model 128 in FIG. 1 and FIG. 2 in accordance with one or more embodiments. Training framework 400 shows how a training dataset may be used to build pairs that are then input into the joint learning model (e.g., joint learning model 128 in FIG. 1 and FIG. 2). Learning from the resulting segmentation maps is performed via supervised learning and contrastive learning.

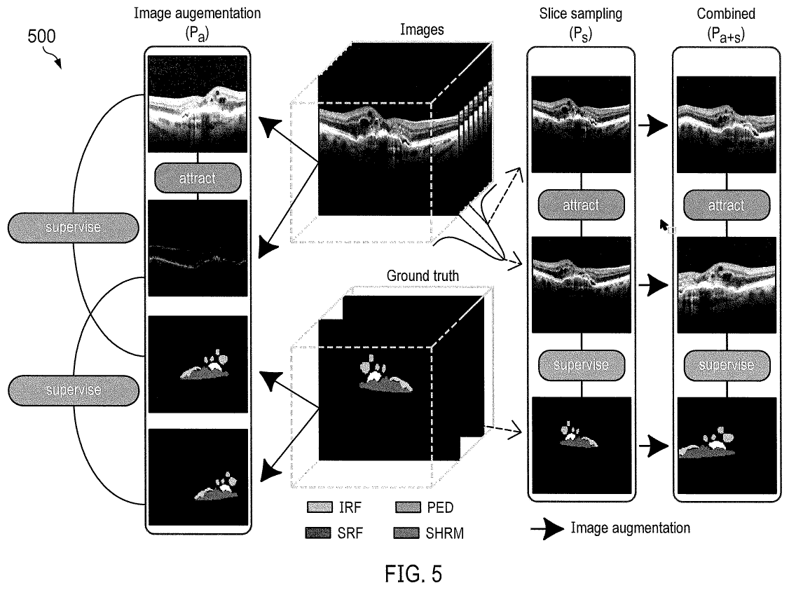

FIG. 5 is a schematic diagram of one example of a training framework 500 that may be used to train joint learning model 128 in FIG. 1 and FIG. 2 in accordance with one or more embodiments. Training framework 500 shows how an augmentation-based pairing strategy may be used, how a slice-based pairing strategy may be used, and how a combination pairing strategy may be used. The combination pairing strategy may rely on the slice-based pairing strategy for the selection of slices (e.g., OCT B-scans) and then the augmentation-based pairing strategy may then be used to generate and build pairs via augmentation.

### III. Example Methodologies for Machine Learning (ML)-Based Retinal Segmentation

### III.A. Automated Retinal Segmentation

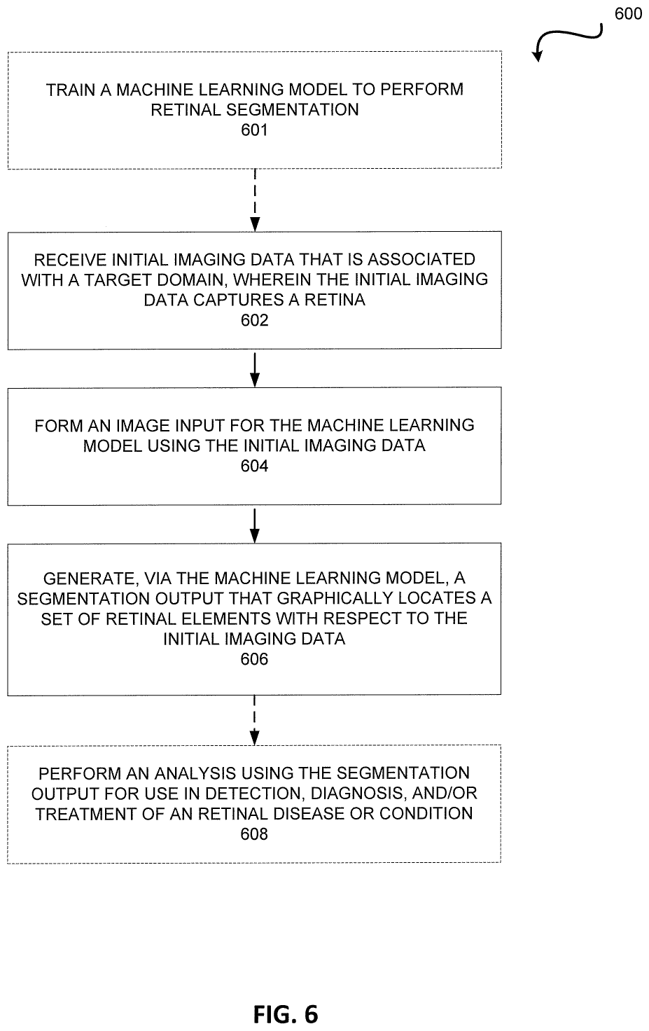

FIG. 6 is a flowchart of a process for analyzing imaging data of a retina of a subject in accordance with one or more example embodiments. Process 600 may be implemented using analysis system 101 in FIG. 1. In one or more embodiments, at least some of the steps of the process 600 may be performed by the processors of a computer or a server implemented as part of analysis system 101. It is understood that additional steps may be performed before, during, or after the steps of process 600 discussed below. In addition, in some embodiments, one or more of the steps may also be omitted or performed in different orders.

Process 600 may optionally include the step 601 of training a machine learning model to perform retinal segmentation. The machine learning model may be, for example, joint learning model 128 in FIGS. 1-2. The machine learning model may include a neural network. The model may be trained using, for example, OCT imaging data (e.g., OCT volumes that are each comprised of multiple OCT B-scans. The machine learning model may be trained using a loss function (e.g., total loss) that combines a supervised learning loss and a contrastive learning loss. In this manner, the machine learning model is a joint learning model that combines supervised and semi-supervised learning and, in particular, contrastive learning.

The machine learning model may be trained using a training dataset that includes labeled imaging data associated with a set of source domains. Each source domain in the set of source domains may be a domain of data for which labeled imaging data is present. For example, the set of source domains may include at least one of first domain 204, second domain 206, or third domain 208 in FIG. 2. The labeled imaging data includes OCT images (e.g., OCT B-scans) and their labeled versions (e.g., the manually annotated versions of these OCT images). In some embodiments, the training dataset further includes unlabeled imaging data associated with one or more source domains of the set of source domains. In some embodiments, the training dataset includes unlabeled imaging data associated with a target domain that is different from any of the source domains in the set of source domains. In some embodiments, the training dataset includes no imaging data, unlabeled or labeled, associated with a target domain that is different from any of the source domains in the set of source domains. The target domain may be the domain of data for which the machine learning model is to be applied after training.

Step 602 of process 600 includes receiving initial imaging data that is associated with a target domain, wherein the initial imaging data captures a retina. The target domain is different from the set of source domains. For example, the target domain may include imaging data acquired from a different imaging device than imaging data associated with the set of source domains. As another example, the target domain may include imaging data that captures a different retinal disease or condition than imaging data associated with the set of source domains.

The initial imaging data may include, for example, an OCT volume comprising a plurality of OCT B-scans of a subject's retina. The subject may have a healthy retina or may have a retina experiencing a retinal disease or condition such as, for example, without limitation, age-related macular degeneration (AMD), neovascular age-related macular degeneration (nAMD), diabetic retinopathy (DR), diabetic macular edema (DME), geographic atrophy (GA), or some other type of retinal disease or condition.

Step 604 of process 600 includes forming an image input for the machine learning model using the initial imaging data. In some cases, forming the image input may include selecting a portion of the initial imaging data for segmentation (e.g., a portion of the plurality of OCT B-scans). In some cases, forming the image input may simply include designating the initial imaging data as input for the machine learning model. In one or more embodiments, forming the image input may include performing at least one preprocessing operation of a set of preprocessing operation on the initial imaging data. The set of preprocessing operations may include, for example, without limitation, at least one of a normalization operation, a scaling operation, a resizing operation, a horizontal flipping operation, a vertical flipping operation, a cropping operation, a rotation operation, a noise filtering operation, or some other type of preprocessing operation.

Step 606 of process 600 includes generating, via the machine learning model, a segmentation output that graphically locates a set of retinal elements with respect to the initial imaging data. The set of retinal elements may be, for example without limitation, segmentation output 126 in FIG. 1. In some embodiments, the set of retinal elements may include, for example without limitation, at least one of intraretinal fluid (IRF), subretinal fluid (SRF), fluid associated with pigment epithelial detachment (PED), hyperreflective material (HRM), subretinal hyperreflective material (SHRM), intraretinal hyperreflective material (IHRM), hyperreflective foci (HRF), a retinal fluid pocket, or a disruption. In one or more embodiments, the set of retinal elements may be associated with a retinal layer, such as for example without limitation, an internal limiting membrane (ILM) layer, an external limiting membrane (ELM) layer, an outer plexiform layer-Henle fiber layer (OPL-HFL), a retinal pigment epithelial (RPE) layer, a layer of RPE detachment, a Bruch's membrane (BM) layer, and an ellipsoid zone (EZ).

In one or more embodiments, segmentation output may include a 2D segmentation map for each OCT B-scan processed by the machine learning model. In some cases, multiple 2D segmentation maps may together form a segmentation volume. A segmentation map may include, for example, at least one of a color indicator, a shape indicator, a pattern indicator, a shading indicator, a line, a curve, a marker, a label, a tag, or text that graphically locates the set of retinal elements relative to the image input.

The machine learning model trained using combined supervised and contrastive learning (e.g., computing combined supervised loss and contrastive loss) may be capable of segmenting imaging data associated with the target domain with the desired level of performance (e.g., accuracy) even where the data used to train the machine learning model includes, in addition to imaging data (labeled and optionally, unlabeled) from the set of source domains, (1) only unlabeled imaging data associated with the target domain (and no labeled imaging data associated with the target domain) or (2) no imaging data (labeled or unlabeled) associated with the target domain. Further, joint learning model 128 may perform well even where only a relatively small amount of unlabeled imaging data associated with the target domain is used. This type of performance makes the machine learning model incredibly versatile and useful across multiple domains. Once trained, the machine learning model may be accurately and reliably used for retinal segmentation across diverse domains such that the machine learning model may be used in complex clinical settings where multiple domains are expected.

Process 600 may optionally include step 608, which includes performing an analysis using the segmentation output for use in detection, diagnosis, and/or treatment of a retinal disease or condition. The retinal disease or condition may be, for example, AMD, nAMD, DR, DME, GA, or some other type of retinal disease or condition. In one or more embodiments, the analysis may be performed using modified segmentation output (e.g., modified segmentation output 136 that has been generated based on the segmentation output 126 generated in step 606).

The analysis in step 608 may include, for example, extracting feature data from the set of retinal elements identified in the segmentation data. The feature data may include values for any number of or combination of features (e.g., quantitative features). Examples of such features may include, but are not limited to, a maximum retinal layer thickness, a minimum retinal layer thickness, an average retinal layer thickness, a maximum height of a boundary associated with a retinal layer, a volume of a retinal fluid pocket, a length of a fluid pocket, a width of a fluid pocket, a number of retinal fluid pockets, and a number of hyperreflective foci. This feature data may be evaluated to automatically diagnose the subject, to automatically detect a selected retinal disease or condition, to identify a treatment recommendation for the subject (e.g., a recommended dosage, treatment regimen, a specific treatment type, etc.), or a combination thereof.

### III.B. Training a Joint Learning Model to Perform Retinal Segmentation

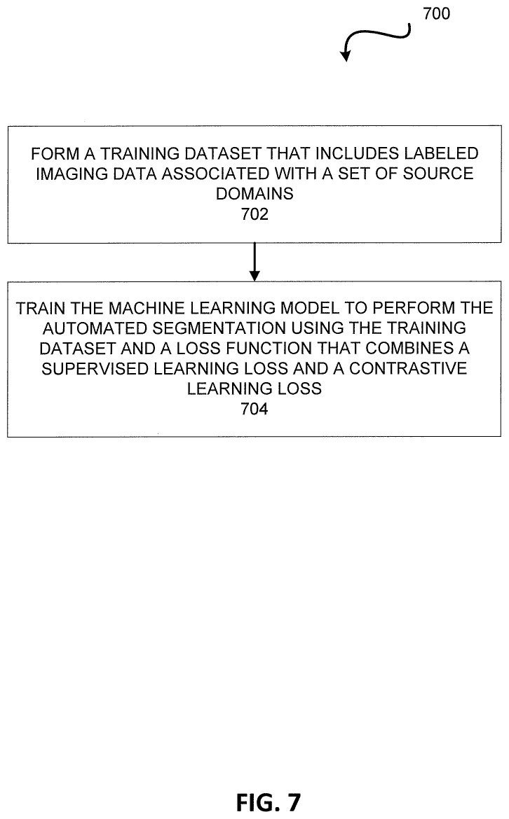

FIG. 7 is a flowchart of a process for training a machine learning model to perform automated segmentation in accordance with one or more embodiments. Process 700 in FIG. 7 may be implemented using analysis system 101 in FIG. 1. Process 700 may be one example of a method for a machine learning model such as, for example, joint learning model 128 in FIG. 2. Process 700 may be one example of an implementation for step 601 in FIG. 6. Further, it is understood that additional steps may be performed before, during, or after the steps of process 700 discussed below. In addition, in some embodiments, one or more steps may also be omitted or performed in different orders.

Step 702 of process 700 includes forming a training dataset that includes labeled imaging data associated with a set of source domains. The training dataset may be, for example, training dataset 200 in FIG. 2. In one or more embodiments, the training dataset may include only labeled imaging data associated with the set of source domains. In other embodiments, the training dataset may further include unlabeled imaging data from at least one source domain of the set of source domains, unlabeled imaging data associated with a target domain, or both. The target domain is different from the set of source domains. The training dataset may exclude any labeled imaging data associated with the target domain.

When the training dataset includes both labeled (and optionally, unlabeled) imaging data from the set of source domains and unlabeled imaging data from the target domain, the machine learning model that results from training using this training dataset may be applied to processing imaging data associated with the target domain according to an unsupervised domain adaptation framework. When the training dataset includes only imaging data (labeled and optionally, unlabeled) from the set of source domains, the machine learning model that results from training using this training dataset may be applied to processing imaging data associated with the target domain according to a zero-shot domain adaptation framework.

Step 704 of process 700 includes training the machine learning model to perform the automated segmentation using the training dataset and a loss function that combines a supervised learning loss and a contrastive learning loss. The machine learning model may be trained according to the example framework described in Section II.B. above. Further, the machine learning model may be trained according to one or more of the methodologies described below in Section IV.

The machine learning model may include a segmentation backbone (e.g., segmentation backbone 222), an encoder (e.g., encoder 224), and a contrastive projection module (e.g., contrastive projection module 226). The segmentation backbone may have, for example, a UNct architecture. The encoder may be, for example, a UNet encoder. The contrastive projection module may be implemented using channel-wise aggregation and may use pairs of images that are built from the training dataset according to at least one of an augmentation-based pairing strategy, a slice-based pairing strategy, or a combination pairing strategy that incorporates both the augmentation-based pairing strategy and the slice-based pairing strategy.

After training, the trained machine learning model may be capable of processing imaging data associated with the target domain to generate a segmentation output with a desired level of performance. As previously discussed, the target domain is different from the set of source domains. The trained machine learning model may be capable of performing automated segmentation of imaging data associated with the target domain with the desired level of performance (e.g., accuracy), even where the data used to train the machine learning model includes, in addition to imaging data (labeled and optionally, unlabeled) from the set of source domains, (1) only unlabeled imaging data associated with the target domain (and no labeled imaging data associated with the target domain) or (2) no imaging data (labeled or unlabeled) associated with the target domain. Further, the trained machine learning model may perform well even in cases where only a relatively small amount of unlabeled imaging data associated with the target domain is used.

### IV. Example Study Using Different Domain Adaptation Frameworks

### IV.A. General Overview of Study

Generally, in this multi-part study (e.g., comprised of multiple experiments), a foundational model was implemented and trained using various techniques to build multiple trained models (e.g., trained joint learning models) and evaluate the performance of these trained models. Each of the resulting trained models described here in Section IV is one example of an implementation for joint learning model 128 in FIG. 1 and FIG. 2. The foundational model, and thereby each of the resulting trained models, included a neural network system having a UNet (or U-Net) based architecture. In one portion of the study, an unsupervised domain adaptation framework was evaluated in which imaging data associated with a source domain D^{s} and imaging data associated with a target domain D^{t} were both used by combining supervised learning and contrastive learning losses. In another portion of the study, a zero-shot domain adaptation framework was evaluated in which training was performed using only labeled imaging data associated with a source domain,

$${D}_{i}^{s} ,$$

performance was evaluated on imaging data associated with a target domain, D^{t}ⱼ, where j≠i, and where no imaging data from the target domain (labeled or unlabeled) is used for training.

### IV.B. Data Used for Training

Three OCT datasets of OCT volumes obtained from different clinical trials were used to form the training datasets for training. Each OCT volume includes a plurality of OCT B-scans (or slices). Each of these three datasets is denoted as a distinct domain, Dᵢ, I∈{1 . . . 3}, where the domain shift is due either to a different acquisition device (imaging device) or retinal disease or condition.

A first domain D₁ included OCT volumes of nAMD patients, acquired using a Spectralis (Heidelberg Engineering) imaging device, yielding scans of 512×496×49 or 768×496×19 voxels, with a resolution of 10×4×111 or 5×4×221 μm/voxel, respectively. These OCT volumes were acquired as part of the phase-2 AVENUE trial (NCT02484690).

A second domain D₂ included OCT volumes of nAMD patients, acquired using a Cirrus HD-OCT III (Carl Zeiss Meditec) imaging device, yielding scans with 512×1024×128 voxels and a resolution of 11.7×47.2×2.0 μm/voxel. These OCT volumes were acquired as part of the phase-3 HARBOR trial (NCT00891735).

A third domain D₃ included OCT volumes of DME patients, acquired using a Spectralis device with scan sizes and resolutions that matched the device used to acquire the OCT volumes of the first domain D₁. These OCT volumes were acquired as part of the phase-2 BOULEVARD trial (NCT02699450).

All slices from the two different devices were resampled to a size of 512×512 pixels with approximately the same resolution of 10×4 μm/pixel. Selected slices from D₁ and D₂ were labeled (e.g., manually annotated) for certain retinal elements: intraretinal fluid (IRF), subretinal fluid (SRF), pigment epithelial detachment (PED), and subretinal hyperreflective material (SHRM). Selected slices from D₃ were annotated for IRF and SRF (not PED or SHRM as these fluid elements are not expected to have diagnostic value for DME patients. Thus, each of D₁, D₂, and D₃, originally included both labeled and unlabeled slices.

For the different training experiments, different ablations were performed to remove labels from specific domains to have different combinations of D^{s} and D^{t}. When a domain was being considered as a D^{t}, the labels were removed and the unlabeled slices were only used for either evaluating performance of the trained model on that domain or training of an UpperBound model that was used as reference for evaluating the proposed trained model on D^{t}.

### IV.C. Joint Learning-Supervised Learning and Self-Supervised Learning

### IV.C.1. Supervised Learning

The foundational model includes a segmentation backbone having a Unet (U-Net) architecture. This segmentation backbone is one example of an implementation for segmentation backbone 222 in FIG. 2. The segmentation backbone may be modeled as F(⋅) processing an image x to predict a segmentation map p=F(x) that approximates a ground truth (e.g., manually annotated) segmentation y. F is learned by minimizing a supervised loss Lₛᵤₚ, which may be the logarithmic Dice loss of labeled imaging data in a source domain D^{s}:

$${ℒ}_{sup} = - {\sum }_{( {p}_{i} , {y}_{i} ) ∈ {D}^{s}} log \frac{2 {\sum }_{j ∈ pixels} {y}_{i}^{j} {p}_{i}^{j}}{ϵ + {\sum }_{j ∈ pixels} ( {y}_{i}^{j} + {p}_{i}^{j} )} \qquad ( 1 )$$

for all training images (xᵢ,yᵢ)∈D^{s}, where ϵ is a small number to avoid division by 0, xᵢ refers to the OCT training image, and yᵢ refers to the labeled version (e.g., manually annotated version) of the OCT training image.

### IV.C.2. Self-Supervised Learning

Self-supervised learning is an intermediate learning between supervised and unsupervised learning. With self-supervised learning, the aim is to learn features h=E(x) with an encoder E(⋅) without using labeled images (e.g., manually annotated) y. The encoder of the model may be implemented using a Unet (or U-Net) based encoder such that the learned features h can be adapted for the intended segmentation task. This type of encoder is one example of an implementation for encoder 224 in FIG. 2.

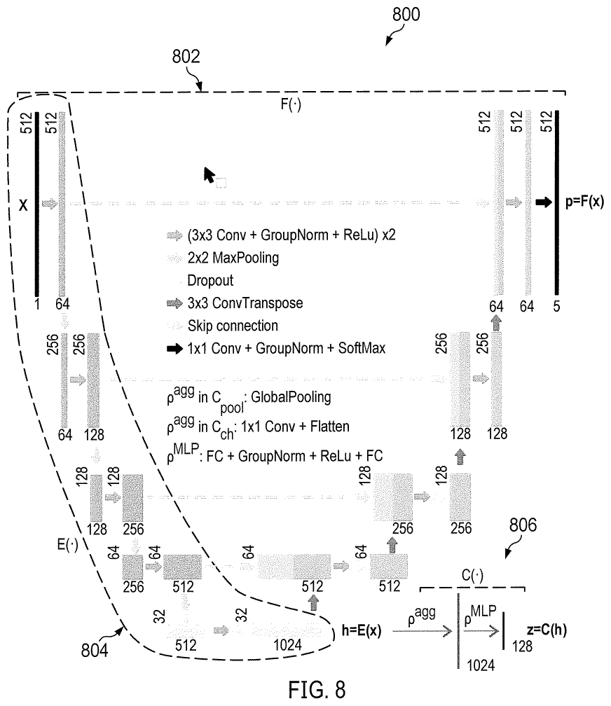

Contrastive learning is one type of self-supervised learning. Contrastive learning may be implemented using a contrastive projection module (or head) C(⋅) that maps the bottleneck-layer features to vector projections z=C(h) on which the contrastive loss L_{con} is applied. One example of the architecture that may be used for E(⋅) and C(⋅) is illustrated in FIG. 8, described below.

FIG. 8 is a schematic diagram of one model architecture 800 for the machine learning model in accordance with one or more embodiments. Model architecture 800, which may also be one example of the architecture used to implement joint learning model 128 in FIG. 1 and FIG. 2, includes segmentation backbone 802, encoder 804, and contrastive projection module 806, which may be examples of implementations for segmentation backbone 222, encoder 224, and contrastive projection module 226, respectively.

Each arrow in model architecture 800 represents a layer(s) with each rectangle representing an output. The width and height of the output vectors is given by the number annotating the corresponding rectangle on the left. The number of features is given by the number annotating the corresponding rectangle on the bottom. For example, output 808 has a width and height of 64 with 512 features.

The contrastive loss L_{con} applied to the vector projections z=C(h) can be implemented using different contrastive loss frameworks, e.g., SimCLR and SimSiam. SimCLR is described in Chen, Ting, et al., “A Simple Framework for Contrastive Learning of Visual Representations,” International Conference on Machine Learning (ICML), pp. 1597-1607, 2020 (available via https://arxiv.org/abs/2002.05709), which is incorporated by reference herein in its entirety. SimSiam is described in Chen, X., He, K., “Exploring Simple Siamese Representation Learning,” IEEE/CVF Conference on Computer Vision and Pattern Recognition, pp. 15750-15758, 2021 (available via https://arxiv.org/abs/2011.10566), which is incorporated by reference herein in its entirety.

With SimCLR, the contrastive loss L_{con} aims to minimize the distance between “positive” pairs of images and maximize the distance to “negative” pairs. The positives

$$( {x}_{i}^{′} , {x}_{i}^{″} )$$

are created from each image xᵢ by a defined pair generator P(⋅) described further below, i.e.,

$$P ( {x}_{i} ) = ( {x}_{i}^{′} , {x}_{i}^{″} ) .$$

The negatives are formed with other images xₖ, k≠i. Loss is evaluating using a version of a normalized temperature-scaled cross entropy loss, as described in Oord, Aaron van den, et al., “Representation Learning with Contrastive Predictive Coding,” arXiv preprint arXiv:1807.03748, 2018 (available via https://arxiv.org/abs/1807.03748), which is incorporated by reference herein in its entirety. Specifically, with SimCLR, the loss is

$${L}_{con}^{CLR} :$$

$${L}_{con}^{CLR} = {\sum }_{P ( {x}_{i} ) , {x}_{i} ∈ D} ( l ( {𝓏}_{i}^{′} , {𝓏}_{i}^{″} ) + l ( {𝓏}_{i}^{″} , {𝓏}_{i}^{′} ) ) \qquad ( 2 )$$

$$l ( {𝓏}_{i}^{′} , {𝓏}_{i}^{″} ) = - log \frac{exp ( d ( {𝓏}_{i}^{′} , {𝓏}_{i}^{″} ) / τ )}{{\sum }_{{x}_{i} ∈ D} {[ k \neq 1 ]}_{} exp ( d ( {𝓏}_{i}^{′} , {𝓏}_{k} ) / τ )} \qquad ( 3 )$$

Where d(u,v)=(u·v)/(∥u∥₂∥v∥₂) and τ is the temperature scaling parameter.

With SimSiam, a learnable predictor Q(⋅) is applied on the projection of each network to predict the projection of the other such that the contrastive loss is

$${L}_{con}^{Siam} :$$

$${L}_{con}^{Siam} = - {\sum }_{{x}_{i} ∈ D} ( d ( Q ( {𝓏}_{i}^{′} ) , {𝓏}_{i}^{″} ) + d ( Q ( {𝓏}_{i}^{″} ) , {𝓏}_{i}^{′} ) ) \qquad ( 4 )$$

where the gradients from the second projection pairs are prevented from back-propagating for network weight updates (stopgrad).

### IV.C.3. Joint Semi-Supervised and Contrastive Learning

The above-described supervised and semi-supervised (e.g., contrastive learning) methodologies are combined to form a semi-supervised framework with Lₛᵤₚ and L_{con} being combined. For a given source domain, D^{s}, and a target domain, D^{t}, total loss, L, is computed using:

$$ℒ = \frac{1}{2} ( {{ℒ}_{con}}_{x ∈ {D}^{s}} + {{ℒ}_{con}}_{x ∈ {D}^{1}} ) + λ {{ℒ}_{sup}}_{( x , y ) ∈ {D}^{s}} \qquad ( 5 )$$

Where λ is a hyperparameter that controls the contribution of Lₛᵤₚ. Thus, learning is performed in a manner that combines supervised learning and contrastive learning by combining supervised learning loss and contrastive learning loss in a unique way.

### IV.C.4. Pair Generation for Contrastive Learning

As discussed above, different types of pair generation functions P(⋅) can be used for volumetric OCT images, where Pₐ is denoted as an OCT adaptation of the augmentation-based pair formation typically used for natural images (e.g., in SimCLR and SimSiam). Here, labeled slices (e.g., OCT B-scans) in the source domain D^{s} and random slices in the target domain D^{t} are augmented with horizontal flipping (e.g., p=0.5), horizontal and vertical translation (e.g., within 25% of the image size), zoom in (e.g., up to 50%), and color distortion (e.g., brightness up to 60% and jittering up to 20%). For color augmentation, images are transformed to RGB, and then back to grayscale.

For contrastive learning, a slice-based pairing Pₛ is used to leverage the coherence of nearby slices in a 3D volume. Here,

$${x}_{i}^{′} = {x}_{i}$$

for a snice index b′ᵢ in 3D and then,

$${x}_{i}^{″}$$

is a slice from the same volume with the (rounded) slice index b″ᵢ sampled from a Gaussian distribution ϕ centered on the index of the original image, i.e. b″ᵢ˜(b′ᵢ,σ), with standard deviation σ as a hyperparameter. Combining the two pairing strategies yields Pₐ₊ₛ where Pₛ is used first and the augmentations in Pₐ are then applied on the selected slices. Thus, three different types of pairing strategies may be used to build the pairs for contrastive learning: Pₐ, Pₛ, and Pₐ₊ₛ.

A contrastive projection module C(⋅) of the model is formed by an aggregation function ρ^{agg} that aggregates features h to form a vector, which is then processed by a multilayer perceptron ρ^{MLP} to create projection z. A semi-supervised model using only SimCLR and SimSiam would include a projection Cₚₒₒₗ where

$${p}_{pool}^{agg} :$$

[symbol]

^{w×h×c}→ [symbol] ^{1×1×c} is a global pooling operation on the width w, height h, and channels c of the input features. It may be challenging with the projection Cₚₒₒₗ for learning representations to leverage segmentation information effectively as backpropagation from L_{con} might lose spatial context. In order to preserve spatial context, a projection Cch may be used for which

$${p}_{ch}^{agg} :$$

[symbol]

^{w×h×c}→ [symbol] ^{w×h×1} is a 1×1×1 convolutional layer that learns how to aggregate layers.

### IV.C.5. Learning Implementation

An Adam optimizer is used with a learning rate of 10⁻³ for all of the training frameworks. Dropout with p=0.5 is applied on the layers of the model. Further, ϕ^{MLP} in the contrastive projection module C(⋅) is formed by two fully-connected layers with 128 units each, where the first one uses group normalization and ReLU activation. Group normalization is used with group size of 4. The hyperparameter λ is heuristically set to 20 and the standard deviation for ϕ for P_{S} is set as σ=0.25 μm, which is the range for which roughly similar features are observed across slices.

### IV.D. Methodologies Used for Evaluation/Testing of the Trained Models

As part of the study, multiple models, including the joint learning models described with respect to the embodiments herein, were trained and compared. Training was replicated for 10 different initialization seeds to reduce the effect of randomness in network initialization of the model. Model performance was evaluated based on 2D slices using the Dice coefficient and Unnormalized Volume Dissimilarity (UVD). The Dice coefficient is reported as a percentage with a higher percentage/score indicating better performance. UVD is reported as μm³×10² with a lower value indicating better performance. UVD measures the extent of total segmentation error (false positives [FP]+false negatives [FN]) on each slice.

All trained models with supervision were trained for 200 epochs, and the model at the epoch with the highest average Dice coefficient across classes on the validation set was selected for evaluation on a holdout test set.

The trained models were first ranked on individual slices of the source domain D^{s} and the target domain D^{t} based on their Dice coefficient and UVD separately. A final ranking was obtained for each trained model by averaging the results across metrics and slices for each of the trained models.

For comparison against the joint learning models, a Baseline model and an UpperBound model were also trained and evaluated. The Baseline model is a supervised UNet model that was trained only on labeled imaging data associated with the source domain D^{s}. The UpperBound model is a supervised UNet model that was trained only on labeled imaging data associated with the target domain D^{t}. This was the only model for which labeled imaging data associated with the target domain D^{t} was used and this data was only used here for comparison purposes.

The SimCLR model uses the contrastive learning framework described above with contrastive loss.

$${L}_{con}^{CLR} .$$

The SimSiam model uses the contrastive learning framework described above with contrastive loss

$${L}_{con}^{Siam} .$$

Both models, however, needed subsequent fine tuning on the source domain after a learning representation is generated for the target domain to be applicable for segmentation on OCT volumes. But needing to fine-tune the output of a model may be less desirable in many situations. The SimCLR model used for comparison in the study was trained using contrastive learning with subsequent finetuning based on the labeled imaging data associated with the source domain, D^{s}. The SimSiam model used for comparison in the study was trained using contrastive learning with subsequent finetuning based on the labeled imaging data associated with the source domain, D^{s}.

Six variations of the joint learning model were used for comparison and were all referred to as “SegCLR” in the study where supervised learning was combined with the SimCLR contrastive learning framework (“SegSiam” included supervised learning combined with the SimSiam contrastive learning framework. A first variation of the joint learning model, SegCLR (Pₐ,Cₚₒₒₗ) incorporated an augmentation-based pairing strategy as described above with an aggregation function that used a global pooling operation. A second variation of the joint learning model, SegCLR (Pₛ,Cₚₒₒₗ) incorporated a slice-based pairing strategy as described above with an aggregation function that used a global pooling operation. A third variation of the joint learning model, SegCLR (P_{a+S},Cₚₒₒₗ) incorporated a combination pairing strategy as described above with an aggregation function that used a global pooling operation. A fourth variation of the joint learning model, SegCLR (Pₐ,C_{ch}) incorporated an augmentation-based pairing strategy as described above with channel-wise aggregation. A fifth variation of the joint learning model, SegCLR (Pₛ,C_{ch}) incorporated a slice-based pairing strategy as described above with channel-wise aggregation. A sixth variation of the joint learning model, SegCLR (Pₐ₊ₛ, C_{ch}) incorporated a combination pairing strategy as described above with channel-wise aggregation.

### IV.E. Study Results

The foundational model was trained using joint learning as described above (e.g., supervised and contrastive learning) and then applied according to an unsupervised domain adaptation framework. The foundational model was trained on (x,y)∈D^{s} and x∈D^{t}, with the trained model then being applied model on x∈D^{t} for evaluation on y∈D^{t}. In other words, training was performed using labeled images associated with the source domain and unlabeled images associated with the target domain, with the trained model then being used to perform segmentation on images associated with the target domain. The trained model was also evaluated on the original source domain y∈D^{s} to assess the retention of source-domain segmentation capability.

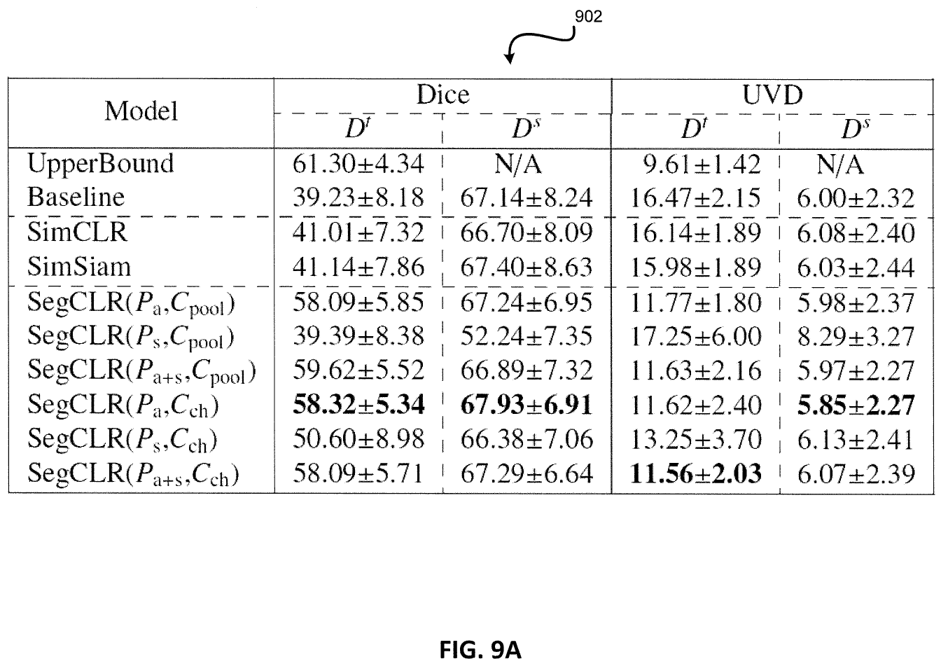

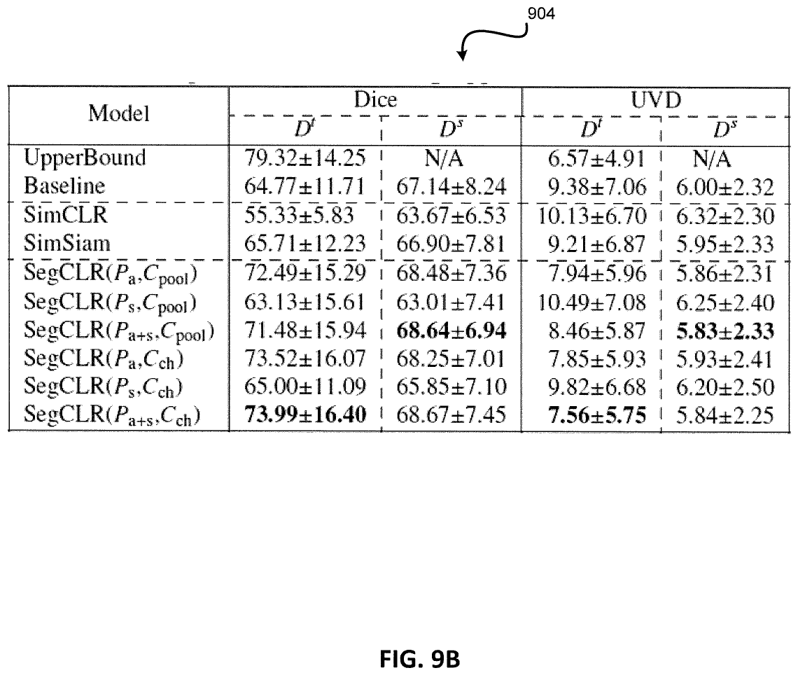

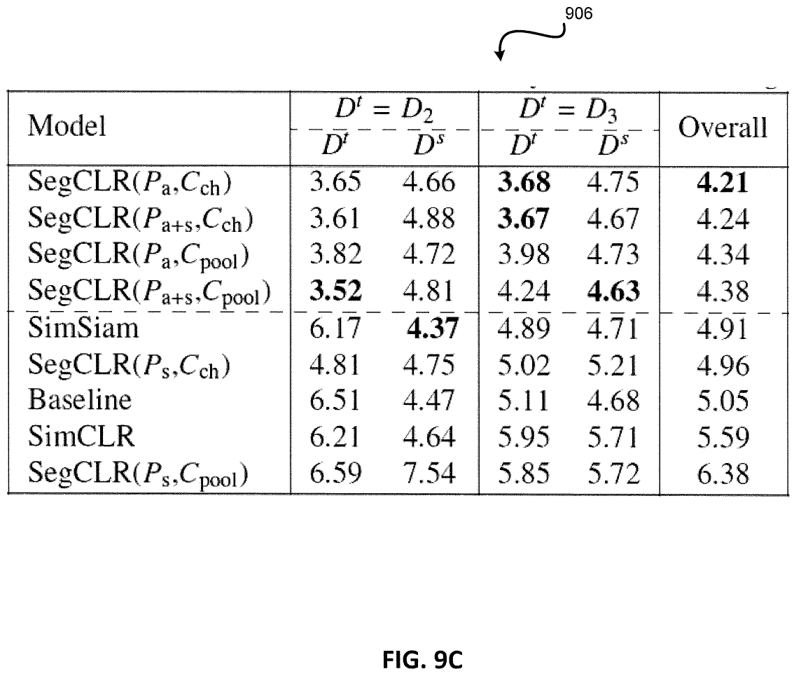

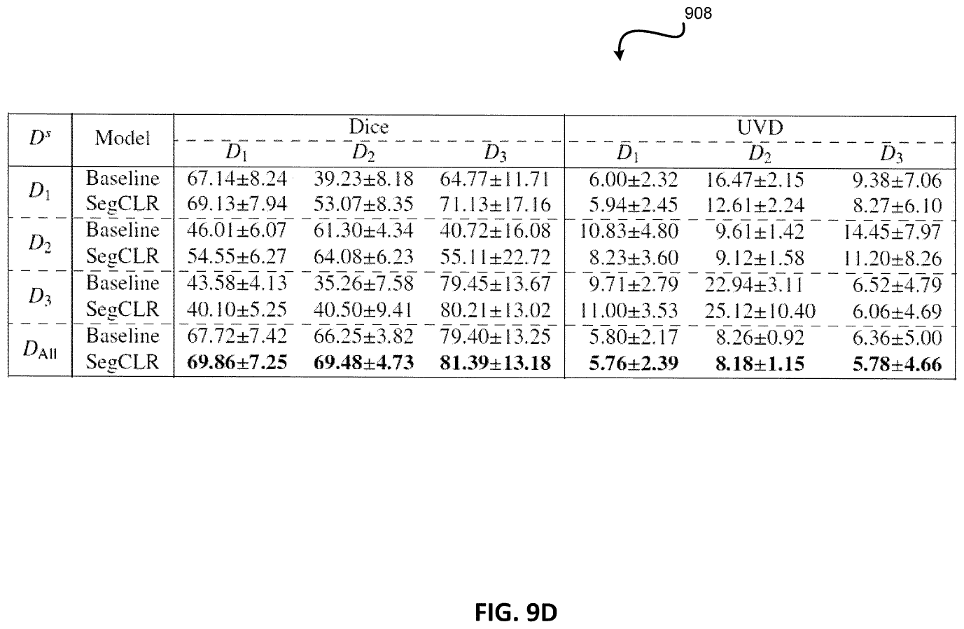

FIG. 9A is a table showing metrics for segmentation performance across classes with respect to the unsupervised domain adaptation framework for different imaging devices in accordance with one or more embodiments. Table 902 includes absolute metrics (e.g., Dice coefficient and Unnormalized Volume Dissimilarity (UVD)) across various trained models. Table 902 compares the performance of the trained models where the domain shift was due to images being acquired with different imaging devices. From the datasets of domain D₁, D₂, and D₃, the source domain D^{t} was chosen to be D₁, since unlabeled images were more limited for this dataset, and the target domain D^{t} was chosen to be D₂.

Table 902 compares the Baseline model, the UpperBound model, the SimCLR model, the SimSiam model, and the six variations of the joint learning model, SegCLR. As shown in table 902, while SegCLR (Pₐ, C_{ch}) showed the best performance, SegCLR (Pₐ₊ₛ, C_{ch}) also had good performance compared to the Baseline model as did many the other SegCLR models. When evaluated on the original source domain y∈D^{s}, the SegCLR models showed good retention of source-domain segmentation capability.

FIG. 9B is a table showing metrics for segmentation performance across classes with respect to the unsupervised domain adaptation framework for different retinal diseases or conditions in accordance with one or more embodiments. Table 904 includes absolute metrics (e.g., Dice coefficient and UVD) across various trained models. Table 904 compares the performance of the trained models where the domain shift was due to images being acquired for retinas with different retinal diseases or conditions. From the datasets of domain D₁, D₂, and D₃, the source domain D^{t} was chosen to be D₁, since unlabeled images were more limited for this dataset, and the target domain D^{t} was chosen to be D₃.

Table 904 compares the Baseline model, the UpperBound model, the SimCLR model, the SimSiam model, and the six variations of the joint learning model, SegCLR. As shown in table 904, while SegCLR (Pₐ₊ₛ, C_{ch}) showed the best performance, SegCLR (Pₐ, C_{ch}) also had good performance compared to the Baseline model as did many of the other SegCLR models. When evaluated on the original source domain y∈D^{t}, the SegCLR models showed good retention of source-domain segmentation capability.

Table 902 in FIG. 9A and table 904 in FIG. 9B show that the joint learning model (SegCLR) designs provided a desired level of performance compared to the Baseline model and nearly reached the performance of the UpperBound model.

Additional experiments were conducted to determine whether the amount of unlabeled imaging data used would affect joint learning model performance. Smaller amounts of unlabeled imaging data being used had a relatively minor effect on performance.

FIG. 9C is a table showing metrics ranking segmentation performance across classes with respect to the unsupervised domain adaptation framework across the domains corresponding to different imaging devices and different retinal diseases in accordance with one or more embodiments. Table 906 shows the average rankings of the various models that were compared based on the evaluation metrics in both table 902 in FIG. 9A and in table 904 in FIG. 9B. The ranking identifies that most of the SegCLR models outperformed relative to the Baseline model. Generally, SegCLR (Pₐ, C_{ch}) performed well across all evaluation options.

FIG. 9D is a table showing metrics for segmentation performance across classes with respect to the zero-shot domain adaptation framework in accordance with one or more embodiments. Table 908 includes absolute metrics (e.g., Dice coefficient and Unnormalized Volume Dissimilarity (UVD)) for comparing the Baseline model and the SegCLR (Pₐ, C_{ch}) model. Specifically, SegCLR (Pₐ,C_{ch}) and the Baseline model were trained using the labeled imaging data for a selected source domain (e.g., leftmost column) of D₁, D₂, and D₃ or on all of the labeled imaging data for all three of these domains, D_{All}=D_{S}=D₁∪D₂∪D₃. The trained models where then evaluated for their segmentation performance with respect to each domain.

Based on the results in table 908, SegCLR works well in the zero-shot adaptation framework where no imaging data from the target domain is used for training. The results in Table 908 indicate that training a multi-domain learning model on all datasets may provide improved segmentation performance on each domain because of the complementary and supporting information that is brought in via the multi-domain setting. SegCLR may effectively augment models by incorporating the contrastive loss even on labeled imaging data, which may enhance model generalizability across datasets. Thus, SegCLR may also be used where there is no domain shift and where there is only labeled data, including for situations where there are multiple domains. SegCLR effectively leverages the data from one type of image content (e.g., eye disease) and/or image appearance (e.g., imaging device) to perform segmentation for a different type of image content and/or image appearance.

### V. Computer Implemented System

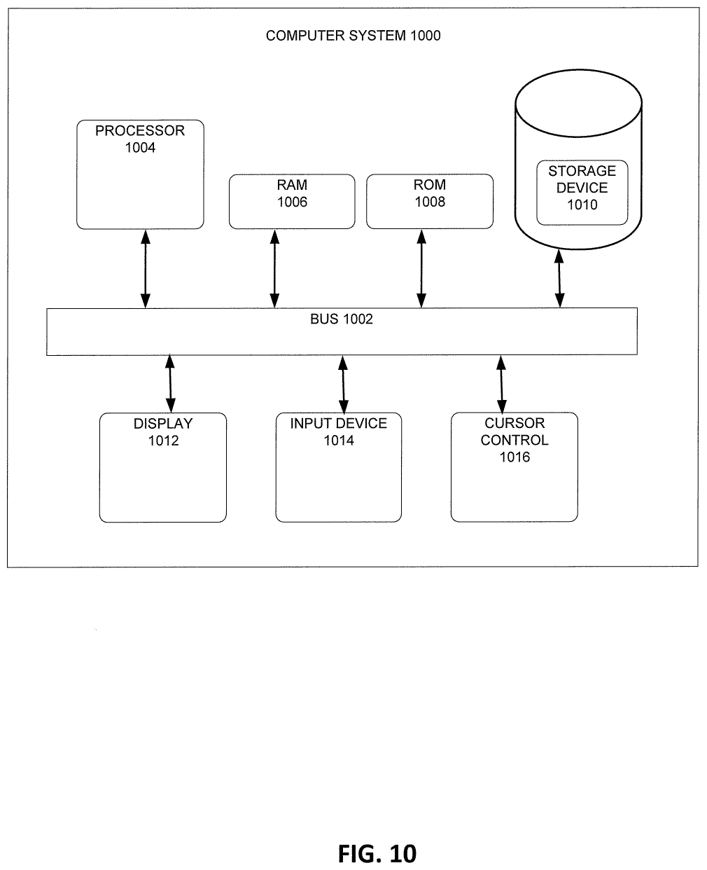

FIG. 10 is a block diagram of a computer system in accordance with various embodiments. Computer system 1000 may be an example of one implementation for computing platform 102 described above in FIG. 1. In one or more examples, computer system 1000 can include a bus 1002 or other communication mechanism for communicating information, and a processor 1004 coupled with bus 1002 for processing information. In various embodiments, computer system 1000 can also include a memory, which can be a random-access memory (RAM) 1006 or other dynamic storage device, coupled to bus 1002 for determining instructions to be executed by processor 1004. Memory also can be used for storing temporary variables or other intermediate information during execution of instructions to be executed by processor 1004. In various embodiments, computer system 1000 can further include a read only memory (ROM) 1008 or other static storage device coupled to bus 1002 for storing static information and instructions for processor 1004. A storage device 1010, such as a magnetic disk or optical disk, can be provided and coupled to bus 1002 for storing information and instructions.

In various embodiments, computer system 1000 can be coupled via bus 1002 to a display 1012, such as a cathode ray tube (CRT) or liquid crystal display (LCD), for displaying information to a computer user. An input device 1014, including alphanumeric and other keys, can be coupled to bus 1002 for communicating information and command selections to processor 1004. Another type of user input device is a cursor control 1016, such as a mouse, a joystick, a trackball, a gesture input device, a gaze-based input device, or cursor direction keys for communicating direction information and command selections to processor 1004 and for controlling cursor movement on display 1012. This input device 1014 typically has two degrees of freedom in two axes, a first axis (e.g., x) and a second axis (e.g., y), that allows the device to specify positions in a plane. However, it should be understood that input devices 1014 allowing for three-dimensional (e.g., x, y and z) cursor movement are also contemplated herein.

Consistent with certain implementations of the present teachings, results can be provided by computer system 1000 in response to processor 1004 executing one or more sequences of one or more instructions contained in RAM 1006. Such instructions can be read into RAM 1006 from another computer-readable medium or computer-readable storage medium, such as storage device 1010. Execution of the sequences of instructions contained in RAM 1006 can cause processor 1004 to perform the processes described herein. Alternatively, hard-wired circuitry can be used in place of or in combination with software instructions to implement the present teachings. Thus, implementations of the present teachings are not limited to any specific combination of hardware circuitry and software.

The term “computer-readable medium” (e.g., data store, data storage, storage device, data storage device, etc.) or “computer-readable storage medium” as used herein refers to any media that participates in providing instructions to processor 1004 for execution. Such a medium can take many forms, including but not limited to, non-volatile media, volatile media, and transmission media. Examples of non-volatile media can include, but are not limited to, optical, solid state, magnetic disks, such as storage device 1010. Examples of volatile media can include, but are not limited to, dynamic memory, such as RAM 1006. Examples of transmission media can include, but are not limited to, coaxial cables, copper wire, and fiber optics, including the wires that comprise bus 1002.

Common forms of computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, PROM, and EPROM, a FLASH-EPROM, any other memory chip or cartridge, or any other tangible medium from which a computer can read.

In addition to computer readable medium, instructions or data can be provided as signals on transmission media included in a communications apparatus or system to provide sequences of one or more instructions to processor 304 of computer system 300 for execution. For example, a communication apparatus may include a transceiver having signals indicative of instructions and data. The instructions and data are configured to cause one or more processors to implement the functions outlined in the disclosure herein. Representative examples of data communications transmission connections can include, but are not limited to, telephone modem connections, wide area networks (WAN), local area networks (LAN), infrared data connections, NFC connections, optical communications connections, etc.

It should be appreciated that the methodologies described herein, flow charts, diagrams, and accompanying disclosure can be implemented using computer system 1000 as a standalone device or on a distributed network of shared computer processing resources such as a cloud computing network.

The methodologies described herein may be implemented by various means depending upon the application. For example, these methodologies may be implemented in hardware, firmware, software, or any combination thereof. For a hardware implementation, the processing unit may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof.

In various embodiments, the methods of the present teachings may be implemented as firmware and/or a software program and applications written in conventional programming languages such as C, C++, Python, etc. If implemented as firmware and/or software, the embodiments described herein can be implemented on a non-transitory computer-readable medium in which a program is stored for causing a computer to perform the methods described above. It should be understood that the various engines described herein can be provided on a computer system, such as computer system 1000, whereby processor 1004 would execute the analyses and determinations provided by these engines, subject to instructions provided by any one of, or a combination of, the memory components RAM 1006, ROM 1008, or storage device 1010 and user input provided via input device 1014.

### VI. Exemplary Definitions and Context

The disclosure is not limited to these exemplary embodiments and applications or to the manner in which the exemplary embodiments and applications operate or are described herein. Moreover, the figures may show simplified or partial views, and the dimensions of elements in the figures may be exaggerated or otherwise not in proportion.

Unless otherwise defined, scientific and technical terms used in connection with the present teachings described herein shall have the meanings that are commonly understood by those of ordinary skill in the art. Further, unless otherwise required by context, singular terms shall include pluralities and plural terms shall include the singular. Generally, nomenclatures utilized in connection with, and techniques of, chemistry, biochemistry, molecular biology, pharmacology and toxicology are described herein are those well-known and commonly used in the art.

In addition, as the terms “on,” “attached to,” “connected to,” “coupled to,” or similar words are used herein, one element (e.g., a component, a material, a layer, a substrate, etc.) can be “on,” “attached to,” “connected to,” or “coupled to” another element regardless of whether the one element is directly on, attached to, connected to, or coupled to the other element or there are one or more intervening elements between the one element and the other element. In addition, where reference is made to a list of elements (e.g., elements a, b, c), such reference is intended to include any one of the listed elements by itself, any combination of less than all of the listed elements, and/or a combination of all of the listed elements. Section divisions in the specification are for case of review only and do not limit any combination of elements discussed.

The term “subject” may refer to a subject of a clinical trial, a person undergoing treatment, a person undergoing anti-cancer therapies, a person being monitored for remission or recovery, a person undergoing a preventative health analysis (e.g., due to their medical history), or any other person or patient of interest. In various cases, “subject” and “patient” may be used interchangeably herein.

As used herein, “substantially” means sufficient to work for the intended purpose. The term “substantially” thus allows for minor, insignificant variations from an absolute or perfect state, dimension, measurement, result, or the like such as would be expected by a person of ordinary skill in the field but that do not appreciably affect overall performance. When used with respect to numerical values or parameters or characteristics that can be expressed as numerical values, “substantially” means within ten percent.

As used herein, the term “about” used with respect to numerical values or parameters or characteristics that can be expressed as numerical values means within ten percent of the numerical values. For example, “about 50” means a value in the range from 45 to 55, inclusive.

The term “ones” means more than one.

As used herein, the term “plurality” can be 2, 3, 4, 5, 6, 7, 8, 9, 10, or more.

As used herein, the term “set of” means one or more. For example, a set of items includes one or more items.

As used herein, the phrase “at least one of,” when used with a list of items, means different combinations of one or more of the listed items may be used and only one of the items in the list may be used. The item may be a particular object, thing, step, operation, process, or category. In other words, “at least one of” means any combination of items or number of items may be used from the list, but not all of the items in the list may be used. For example, without limitation, “at least one of item A, item B, or item C” means item A; item A and item B; item B; item A, item B, and item C; item B and item C; or item A and C. In some cases, “at least one of item A, item B, or item C” means, but is not limited to, two of item A, one of item B, and ten of item C; four of item B and seven of item C; or some other suitable combination.

As used herein, a “model” may include one or more algorithms, one or more mathematical techniques, one or more machine learning algorithms, or a combination thereof.

As used herein, “machine learning” may include the practice of using algorithms to parse data, learn from it, and then make a determination or prediction about something in the world. Machine learning may use algorithms that can learn from data without relying on rules-based programming. Deep learning may be one form of machine learning.

As used herein, an “artificial neural network” or “neural network” (NN) may refer to mathematical algorithms or computational models that mimic an interconnected group of artificial neurons that processes information based on a connectionistic approach to computation. Neural networks, which may also be referred to as neural nets, can employ one or more layers of nonlinear units to predict an output for a received input. Some neural networks may include one or more hidden layers in addition to an output layer. The output of each hidden layer may be used as input to the next layer in the network, i.e., the next hidden layer or the output layer. Each layer of the network generates an output from a received input in accordance with current values of a respective set of parameters. In the various embodiments, a reference to a “neural network” may be a reference to one or more neural networks.

A neural network may process information in two ways; when it is being trained it is in training mode and when it puts what it has learned into practice it is in inference (or prediction) mode. Neural networks may learn through a feedback process (e.g., backpropagation) which allows the network to adjust the weight factors (modifying its behavior) of the individual nodes in the intermediate hidden layers so that the output matches the outputs of the training data. In other words, a neural network may learn by being fed training data (learning examples) and eventually learns how to reach the correct output, even when it is presented with a new range or set of inputs. A neural network may include, for example, without limitation, at least one of a Feedforward Neural Network (FNN), a Recurrent Neural Network (RNN), a Modular Neural Network (MNN), a Convolutional Neural Network (CNN), a Residual Neural Network (ResNet), an Ordinary Differential Equations Neural Networks (neural-ODE), a U-Net, a fully convolutional network (FCN), a stacked FCN, a stacked FCN with multi-channel learning, a Squeeze and Excitation embedded neural network, a MobileNet, or another type of neural network.

As used herein, “deep learning” may refer to the use of multi-layered artificial neural networks to automatically learn representations from input data such as images, video, text, etc., without human provided knowledge, to deliver highly accurate predictions in tasks such as object detection/identification, speech recognition, language translation, etc.

### VII. Recitation of Example Embodiments

Embodiment 1: A method comprising: receiving initial imaging data that is associated with a target domain, wherein the initial imaging data captures a retina; forming an image input for a machine learning model using the initial imaging data; and generating, via the machine learning model, a segmentation output that graphically locates a set of retinal elements with respect to the initial imaging data, wherein the machine learning model has been trained using a loss function that combines a supervised learning loss and a contrastive learning loss; and wherein the machine learning model has been trained using a training dataset that includes labeled imaging data associated with a set of source domains, the set of source domains being different from the target domain.

Embodiment 2: The method of embodiment 1, wherein the training dataset further includes unlabeled imaging data associated with the target domain.

Embodiment 3: The method of embodiment 1 or embodiment 2, wherein the training dataset further includes unlabeled imaging data associated with at least one source domain of the set of source domains.

Embodiment 4: The method of any one of embodiments 1-3, wherein the target domain includes imaging data acquired from a different imaging device than imaging data associated with the set of source domains.

Embodiment 5: The method of any one of embodiments 1-4, wherein the target domain includes imaging data that captures a different retinal disease or condition than imaging data associated with the set of source domains.

Embodiment 6: The method of any one of embodiments 1-5, wherein the initial imaging data comprises an OCT volume that comprises a plurality of OCT B-scans.

Embodiment 7: The method of any one of embodiments 1-6, wherein the machine learning model is a joint learning model that includes a segmentation backbone, an encoder, and a contrastive projection module.

Embodiment 8: The method of embodiment 7, wherein the segmentation backbone comprises a UNet architecture.

Embodiment 9: The method of embodiment 7 or embodiment 8, wherein the encoder comprises a UNet encoder.

Embodiment 10: The method of any one of embodiments 7-9, wherein the contrastive projection module performs channel-wise aggregation and learns from pairs of images that are built using at least one of an augmentation-based pairing strategy, a slice-based pairing strategy, or a combination pairing strategy that incorporates both the augmentation-based pairing strategy and the slice-based pairing strategy.

Embodiment 11: The method of embodiment 10, wherein the training dataset includes an OCT volume that includes a plurality of OCT B-scans, and wherein the augmentation-based pairing strategy comprises building a positive pair that includes selecting an OCT B-scan from the plurality of OCT B-scans as a first image of the positive pair and augmenting the OCT B-scan to form a second image of the positive pair, wherein augmenting the OCT B-scan includes at least one of horizontal flipping, horizontal translation, vertical translation, zooming in, zooming out, or color distortion.

Embodiment 12: The method of embodiment 10 or 11, wherein the training dataset includes an OCT volume that includes a plurality of OCT B-scans, and wherein the slice-based pairing strategy comprises building a positive pair that includes selecting a first OCT B-scan from the plurality of OCT B-scans as a first image and selecting a second OCT B-scan from the plurality of OCT B-scans as a second image in which the second OCT B-scan is within a selected distance from the first OCT B-scan.

Embodiment 13: The method of any one of embodiments 10-12, wherein the combination pairing strategy comprises building a pair of images using the slice-based pairing strategy and augmenting at least one image of the pair of images using the augmentation-based pairing strategy.

Embodiment 14: The method of any one of embodiments 1-13, wherein forming the image input using the initial imaging data comprises:

performing at least one of a normalization operation, a scaling operation, a resizing operation, a horizontal flipping operation, a vertical flipping operation, a cropping operation, a rotation operation, or a noise filtering operation.

Embodiment 15: The method of any one of embodiments 1-14, wherein a retinal element of the set of retinal elements comprises at least one of intraretinal fluid (IRF), subretinal fluid (SRF), fluid associated with pigment epithelial detachment (PED), hyperreflective material (HRM), subretinal hyperreflective material (SHRM), intraretinal hyperreflective material (IHRM), hyperreflective foci (HRF), a retinal fluid pocket, or a disruption.

Embodiment 16: The method of any one of embodiments 1-15, wherein a retinal element of the set of retinal elements is associated with a retinal layer selected from a group consisting of an internal limiting membrane (ILM) layer, an external limiting membrane (ELM) layer, an outer plexiform layer-Henle fiber layer (OPL-HFL), a retinal pigment epithelial (RPE) layer, a layer of RPE detachment, a Bruch's membrane (BM) layer, and an ellipsoid zone (EZ).

Embodiment 17: The method of any one of embodiments 1-16, wherein the segmentation output comprises a segmentation map that comprises at least one of a color indicator, a shape indicator, a pattern indicator, a shading indicator, a line, a curve, a marker, a label, a tag, or text that graphically locates at least one retinal element of the set of retinal elements.

Embodiment 18: A method for training a machine learning model to perform automated segmentation, the method comprising: forming a training dataset that includes labeled imaging data associated with a set of source domains; and training the machine learning model to perform the automated segmentation using the training dataset and a loss function that combines a supervised learning loss and a contrastive learning loss, wherein the trained machine learning model is capable of processing imaging data associated with a target domain to generate a segmentation output with a desired level of performance; wherein the target domain is different from the set of source domains; and wherein the training dataset excludes any labeled imaging data associated with the target domain.

Embodiment 19: The method of embodiment 18, wherein the training dataset further includes unlabeled imaging data associated with the target domain.

Embodiment 20: The method of embodiment 18 or embodiment 19, wherein the training dataset further includes unlabeled imaging data associated with at least one source domain of the set of source domains.

Embodiment 21: The method of any one of embodiments 18-20, wherein the target domain includes imaging data acquired from a different imaging device than imaging data associated with the set of source domains.

Embodiment 22: The method of any one of embodiments 18-21, wherein the target domain includes imaging data that captures a different retinal disease or condition than imaging data associated with the set of source domains.

Embodiment 23: The method of any one of embodiments 18-22, wherein machine learning model is a joint learning model that includes a segmentation backbone, an encoder, and a contrastive projection module.

Embodiment 24: The method of embodiment 23, wherein the segmentation backbone comprises a UNet architecture, wherein the encoder comprises a UNet encoder, and wherein the contrastive projection module performs channel-wise aggregation.

Embodiment 25: The method of any one of embodiments 18-24, wherein the training dataset includes an OCT volume that comprises a plurality of OCT B-scans and wherein training the machine learning model comprises: building a plurality of pairs using the training dataset for use in computing the contrastive learning lost using at least one of an augmentation-based pairing strategy, a slice-based pairing strategy, or a combination pairing strategy that incorporates both the augmentation-based pairing strategy and the slice-based pairing strategy.

Embodiment 26: The method of embodiment 25, wherein the augmentation-based pairing strategy comprises building a positive pair that includes selecting an OCT B-scan from the plurality of OCT B-scans as a first image of the positive pair and augmenting the OCT B-scan to form a second image of the positive pair, wherein augmenting the OCT B-scan includes at least one of horizontal flipping, horizontal translation, vertical translation, zooming in, zooming out, or color distortion.

Embodiment 27: The method of embodiment 25 or embodiment 26, wherein the slice-based pairing strategy comprises building a positive pair that includes selecting a first OCT B-scan from the plurality of OCT B-scans as a first image and selecting a second OCT B-scan from the plurality of OCT B-scans as a second image in which the second OCT B-scan is within a selected distance from the first OCT B-scan.

Embodiment 28: The method of any one of embodiments 25-27, wherein the combination pairing strategy comprises building a pair of images using the slice-based pairing strategy and augmenting at least one image of the pair of images using the augmentation-based pairing strategy.

Embodiment 29: A system comprising: one or more data processors; and a non-transitory computer readable storage medium containing instructions which, when executed on the one or more data processors, cause the one or more data processors to: receive initial imaging data that is associated with a target domain, wherein the initial imaging data captures a retina; form image input for a machine learning model using the initial imaging data; and generate, via the machine learning model, a segmentation output that graphically locates a set of retinal elements with respect to the initial imaging data, wherein the machine learning model has been trained using a loss function that combines a supervised learning loss and a contrastive learning loss; and wherein the machine learning model has been trained using a training dataset that includes labeled imaging data associated with a set of source domains, the set of source domains being different from the target domain.

Embodiment 30: The system of embodiment 29, wherein the training dataset further includes unlabeled imaging data associated with the target domain.

Embodiment 31: The system of embodiment 29 or embodiment 30, wherein the training dataset further includes unlabeled imaging data associated with at least one source domain of the set of source domains.

Embodiment 32: The system of any one of embodiments 29-31, wherein the target domain includes imaging data acquired from a different imaging device than imaging data associated with the set of source domains.

Embodiment 33: The system of any one of embodiments 29-32, wherein the target domain includes imaging data that captures a different retinal disease or condition than imaging data associated with the set of source domains.

Embodiment 34: The system of any one of embodiments 29-33, wherein the initial imaging data comprises an OCT volume that comprises a plurality of OCT B-scans.

Embodiment 35: The system of any one of embodiments 29-34, wherein the machine learning model is a joint learning model that includes a segmentation backbone, an encoder, and a contrastive projection module.

Embodiment 36: The system of embodiment 35, wherein the segmentation backbone comprises a UNet architecture.

Embodiment 37: The system of embodiment 35 or embodiment 36, wherein the encoder comprises a UNet encoder.

Embodiment 38: The system of any one of embodiments 35-37, wherein the contrastive projection module performs channel-wise aggregation and learns from pairs of images that are built using at least one of an augmentation-based pairing strategy, a slice-based pairing strategy, or a combination pairing strategy that incorporates both the augmentation-based pairing strategy and the slice-based pairing strategy.

Embodiment 39: The system of embodiment 38, wherein the training dataset includes an OCT volume that includes a plurality of OCT B-scans, and wherein the augmentation-based pairing strategy comprises building a positive pair that includes selecting an OCT B-scan from the plurality of OCT B-scans as a first image of the positive pair and augmenting the OCT B-scan to form a second image of the positive pair, wherein augmenting the OCT B-scan includes at least one of horizontal flipping, horizontal translation, vertical translation, zooming in, zooming out, or color distortion.

Embodiment 40: The system of embodiment 38 or 39, wherein the training dataset includes an OCT volume that includes a plurality of OCT B-scans, and wherein the slice-based pairing strategy comprises building a positive pair that includes selecting a first OCT B-scan from the plurality of OCT B-scans as a first image and selecting a second OCT B-scan from the plurality of OCT B-scans as a second image in which the second OCT B-scan is within a selected distance from the first OCT B-scan.

Embodiment 41: The system of any one of embodiments 38-40, wherein the combination pairing strategy comprises building a pair of images using the slice-based pairing strategy and augmenting at least one image of the pair of images using the augmentation-based pairing strategy.

Embodiment 42: The system of any one of embodiments 29-41, wherein forming the image input using the initial imaging data comprises: performing at least one of a normalization operation, a scaling operation, a resizing operation, a horizontal flipping operation, a vertical flipping operation, a cropping operation, a rotation operation, or a noise filtering operation.

Embodiment 43: The system of any one of embodiments 29-42, wherein a retinal element of the set of retinal elements comprises at least one of intraretinal fluid (IRF), subretinal fluid (SRF), fluid associated with pigment epithelial detachment (PED), hyperreflective material (HRM), subretinal hyperreflective material (SHRM), intraretinal hyperreflective material (IHRM), hyperreflective foci (HRF), a retinal fluid pocket, or a disruption.

Embodiment 44: The system of any one of embodiments 29-43, wherein a retinal element of the set of retinal elements is associated with a retinal layer selected from a group consisting of an internal limiting membrane (ILM) layer, an external limiting membrane (ELM) layer, an outer plexiform layer-Henle fiber layer (OPL-HFL), a retinal pigment epithelial (RPE) layer, a layer of RPE detachment, a Bruch's membrane (BM) layer, and an ellipsoid zone (EZ).

Embodiment 45: The system of any one of embodiments 29-44, wherein the segmentation output comprises a segmentation map that comprises at least one of a color indicator, a shape indicator, a pattern indicator, a shading indicator, a line, a curve, a marker, a label, a tag, or text that graphically locates at least one retinal element of the set of retinal elements.

Embodiment 46: A system for training a machine learning model to perform automated segmentation, the system comprising: one or more data processors; and a non-transitory computer readable storage medium containing instructions which, when executed on the one or more data processors, cause the one or more data processors to: form a training dataset that includes labeled imaging data associated with a set of source domains; and train the machine learning model to perform the automated segmentation using the training dataset and a loss function that combines a supervised learning loss and a contrastive learning loss, wherein the trained machine learning model is capable of processing imaging data associated with a target domain to generate a segmentation output with a desired level of performance; wherein the target domain is different from the set of source domains; and wherein the training dataset excludes any labeled imaging data associated with the target domain.

Embodiment 47: The system of embodiment 46, wherein the training dataset further includes unlabeled imaging data associated with the target domain.

Embodiment 48: The system of embodiment 46 or embodiment 47, wherein the training dataset further includes unlabeled imaging data associated with at least one source domain of the set of source domains.

Embodiment 49: The system of any one of embodiments 46-48, wherein the target domain includes imaging data acquired from a different imaging device than imaging data associated with the set of source domains.

Embodiment 50: The system of any one of embodiments 46-48, wherein the target domain includes imaging data that captures a different retinal disease or condition than imaging data associated with the set of source domains.

Embodiment 51: The system of any one of embodiments 46-50, wherein machine learning model is a joint learning model that includes a segmentation backbone, an encoder, and a contrastive projection module.

Embodiment 52: The system of embodiment 51, wherein the segmentation backbone comprises a UNet architecture, wherein the encoder comprises a UNet encoder, and wherein the contrastive projection module performs channel-wise aggregation.

Embodiment 53: The system of any one of embodiments 46-52, wherein the training dataset includes an OCT volume that comprises a plurality of OCT B-scans and wherein training the machine learning model comprises: building a plurality of pairs using the training dataset for use in computing the contrastive learning lost using at least one of an augmentation-based pairing strategy, a slice-based pairing strategy, or a combination pairing strategy that incorporates both the augmentation-based pairing strategy and the slice-based pairing strategy.

Embodiment 54: The system of embodiment 53, wherein the augmentation-based pairing strategy comprises building a positive pair that includes selecting an OCT B-scan from the plurality of OCT B-scans as a first image of the positive pair and augmenting the OCT B-scan to form a second image of the positive pair, wherein augmenting the OCT B-scan includes at least one of horizontal flipping, horizontal translation, vertical translation, zooming in, zooming out, or color distortion.

Embodiment 55: The system of embodiment 53 or embodiment 54, wherein the slice-based pairing strategy comprises building a positive pair that includes selecting a first OCT B-scan from the plurality of OCT B-scans as a first image and selecting a second OCT B-scan from the plurality of OCT B-scans as a second image in which the second OCT B-scan is within a selected distance from the first OCT B-scan.

Embodiment 56: The system of any one of embodiments 53-55, wherein the combination pairing strategy comprises building a pair of images using the slice-based pairing strategy and augmenting at least one image of the pair of images using the augmentation-based pairing strategy.

Embodiment 57: A system comprising: one or more data processors; and a non-transitory computer readable storage medium containing instructions which, when executed on the one or more data processors, cause the one or more data processors to perform part or all of one or more methods disclosed in embodiments 1-28.

Embodiment 58: A computer-program product tangibly embodied in a non-transitory machine-readable storage medium, including instructions configured to cause one or more data processors to perform part or all of one or more methods disclosed in embodiments 1-28.

### VIII. Additional Considerations

While the present teachings are described in conjunction with various embodiments, it is not intended that the present teachings be limited to such embodiments. On the contrary, the present teachings encompass various alternatives, modifications, and equivalents, as will be appreciated by those of skill in the art.

For example, the flowcharts and block diagrams described above illustrate the architecture, functionality, and/or operation of possible implementations of various method and system embodiments. Each block in the flowcharts or block diagrams may represent a module, a segment, a function, a portion of an operation or step, or a combination thereof. In some alternative implementations of an embodiment, the function or functions noted in the blocks may occur out of the order noted in the figures. For example, in some cases, two blocks shown in succession may be executed substantially concurrently. In other cases, the blocks may be performed in the reverse order. Further, in some cases, one or more blocks may be added to replace or supplement one or more other blocks in a flowchart or block diagram.

Thus, in describing the various embodiments, the specification may have presented a method and/or process as a particular sequence of steps. However, to the extent that the method or process does not rely on the particular order of steps set forth herein, the method or process should not be limited to the particular sequence of steps described, and one skilled in the art can readily appreciate that the sequences may be varied and still remain within the spirit and scope of the various embodiments.

What is claimed is:

1. A method comprising:
receiving initial imaging data that is associated with a target domain, wherein the initial imaging data captures a retina;
forming an image input for a machine learning model using the initial imaging data; and
generating, via the machine learning model, a segmentation output that graphically locates a set of retinal elements with respect to the initial imaging data,
wherein the machine learning model has been trained using a loss function that combines a supervised learning loss and a contrastive learning loss; and
wherein the machine learning model has been trained using a training dataset that includes labeled imaging data associated with a set of source domains, the set of source domains being different from the target domain.

2. The method of claim 1, wherein the training dataset further includes unlabeled imaging data associated with the target domain.

3. The method of claim 1 or claim 2, wherein the training dataset further includes unlabeled imaging data associated with at least one source domain of the set of source domains.

4. The method of any one of claims 1-3, wherein the target domain includes imaging data acquired from a different imaging device than imaging data associated with the set of source domains.

5. The method of any one of claims 1-4, wherein the target domain includes imaging data that captures a different retinal disease or condition than imaging data associated with the set of source domains.

6. The method of any one of claims 1-5, wherein the initial imaging data comprises an OCT volume that comprises a plurality of OCT B-scans.

7. The method of any one of claims 1-6, wherein the machine learning model is a joint learning model that includes a segmentation backbone, an encoder, and a contrastive projection module.

8. The method of claim 7, wherein the segmentation backbone comprises a UNet architecture.

9. The method of claim 7 or claim 8, wherein the encoder comprises a UNet encoder.

10. The method of any one of claims 7-9, wherein the contrastive projection module performs channel-wise aggregation and learns from pairs of images that are built using at least one of an augmentation-based pairing strategy, a slice-based pairing strategy, or a combination pairing strategy that incorporates both the augmentation-based pairing strategy and the slice-based pairing strategy.

11. The method of claim 10, wherein the training dataset includes an OCT volume that includes a plurality of OCT B-scans, and wherein the augmentation-based pairing strategy comprises building a positive pair that includes selecting an OCT B-scan from the plurality of OCT B-scans as a first image of the positive pair and augmenting the OCT B-scan to form a second image of the positive pair, wherein augmenting the OCT B-scan includes at least one of horizontal flipping, horizontal translation, vertical translation, zooming in, zooming out, or color distortion.

12. The method of claim 10 or 11, wherein the training dataset includes an OCT volume that includes a plurality of OCT B-scans, and wherein the slice-based pairing strategy comprises building a positive pair that includes selecting a first OCT B-scan from the plurality of OCT B-scans as a first image and selecting a second OCT B-scan from the plurality of OCT B-scans as a second image in which the second OCT B-scan is within a selected distance from the first OCT B-scan.

13. The method of any one of claims 10-12, wherein the combination pairing strategy comprises building a pair of images using the slice-based pairing strategy and augmenting at least one image of the pair of images using the augmentation-based pairing strategy.

14. The method of any one of claims 1-13, wherein forming the image input using the initial imaging data comprises:
performing at least one of a normalization operation, a scaling operation, a resizing operation, a horizontal flipping operation, a vertical flipping operation, a cropping operation, a rotation operation, or a noise filtering operation.

15. The method of any one of claims 1-14, wherein a retinal element of the set of retinal elements comprises at least one of intraretinal fluid (IRF), subretinal fluid (SRF), fluid associated with pigment epithelial detachment (PED), hyperreflective material (HRM), subretinal hyperreflective material (SHRM), intraretinal hyperreflective material (IHRM), hyperreflective foci (HRF), a retinal fluid pocket, or a disruption.

16. The method of any one of claims 1-15, wherein a retinal element of the set of retinal elements is associated with a retinal layer selected from a group consisting of an internal limiting membrane (ILM) layer, an external limiting membrane (ELM) layer, an outer plexiform layer-Henle fiber layer (OPL-HFL), a retinal pigment epithelial (RPE) layer, a layer of RPE detachment, a Bruch's membrane (BM) layer, and an ellipsoid zone (EZ).

17. The method of any one of claims 1-16, wherein the segmentation output comprises a segmentation map that comprises at least one of a color indicator, a shape indicator, a pattern indicator, a shading indicator, a line, a curve, a marker, a label, a tag, or text that graphically locates at least one retinal element of the set of retinal elements.

18. A method for training a machine learning model to perform automated segmentation, the method comprising:
forming a training dataset that includes labeled imaging data associated with a set of source domains; and
training the machine learning model to perform the automated segmentation using the training dataset and a loss function that combines a supervised learning loss and a contrastive learning loss,
wherein the trained machine learning model is capable of processing imaging data associated with a target domain to generate a segmentation output with a desired level of performance;
wherein the target domain is different from the set of source domains; and
wherein the training dataset excludes any labeled imaging data associated with the target domain.

19. The method of claim 18, wherein the training dataset further includes unlabeled imaging data associated with the target domain.

20. The method of claim 18 or claim 19, wherein the training dataset further includes unlabeled imaging data associated with at least one source domain of the set of source domains.

21. The method of any one of claims 18-20, wherein the target domain includes imaging data acquired from a different imaging device than imaging data associated with the set of source domains.

22. The method of any one of claims 18-21, wherein the target domain includes imaging data that captures a different retinal disease or condition than imaging data associated with the set of source domains.

23. The method of any one of claims 18-22, wherein machine learning model is a joint learning model that includes a segmentation backbone, an encoder, and a contrastive projection module.

24. The method of claim 23, wherein the segmentation backbone comprises a UNet architecture, wherein the encoder comprises a UNet encoder, and wherein the contrastive projection module performs channel-wise aggregation.

25. The method of any one of claims 18-24, wherein the training dataset includes an OCT volume that comprises a plurality of OCT B-scans and wherein training the machine learning model comprises:
building a plurality of pairs using the training dataset for use in computing the contrastive learning lost using at least one of an augmentation-based pairing strategy, a slice-based pairing strategy, or a combination pairing strategy that incorporates both the augmentation-based pairing strategy and the slice-based pairing strategy.

26. The method of claim 25, wherein the augmentation-based pairing strategy comprises building a positive pair that includes selecting an OCT B-scan from the plurality of OCT B-scans as a first image of the positive pair and augmenting the OCT B-scan to form a second image of the positive pair, wherein augmenting the OCT B-scan includes at least one of horizontal flipping, horizontal translation, vertical translation, zooming in, zooming out, or color distortion.

27. The method of claim 25 or claim 26, wherein the slice-based pairing strategy comprises building a positive pair that includes selecting a first OCT B-scan from the plurality of OCT B-scans as a first image and selecting a second OCT B-scan from the plurality of OCT B-scans as a second image in which the second OCT B-scan is within a selected distance from the first OCT B-scan.

28. The method of any one of claims 25-27, wherein the combination pairing strategy comprises building a pair of images using the slice-based pairing strategy and augmenting at least one image of the pair of images using the augmentation-based pairing strategy.

29. A system comprising:
one or more data processors; and
a non-transitory computer readable storage medium containing instructions which, when executed on the one or more data processors, cause the one or more data processors to:
receive initial imaging data that is associated with a target domain, wherein the initial imaging data captures a retina;
form image input for a machine learning model using the initial imaging data; and
generate, via the machine learning model, a segmentation output that graphically locates a set of retinal elements with respect to the initial imaging data,
wherein the machine learning model has been trained using a loss function that combines a supervised learning loss and a contrastive learning loss; and
wherein the machine learning model has been trained using a training dataset that includes labeled imaging data associated with a set of source domains, the set of source domains being different from the target domain.

30. The system of claim 29, wherein the training dataset further includes unlabeled imaging data associated with the target domain.

31. The system of claim 29 or claim 30, wherein the training dataset further includes unlabeled imaging data associated with at least one source domain of the set of source domains.

32. The system of any one of claims 29-31, wherein the target domain includes imaging data acquired from a different imaging device than imaging data associated with the set of source domains.

33. The system of any one of claims 29-32, wherein the target domain includes imaging data that captures a different retinal disease or condition than imaging data associated with the set of source domains.

34. The system of any one of claims 29-33, wherein the initial imaging data comprises an OCT volume that comprises a plurality of OCT B-scans.

35. The system of any one of claims 29-34, wherein the machine learning model is a joint learning model that includes a segmentation backbone, an encoder, and a contrastive projection module.

36. The system of claim 35, wherein the segmentation backbone comprises a UNet architecture.

37. The system of claim 35 or claim 36, wherein the encoder comprises a UNet encoder.

38. The system of any one of claims 35-37, wherein the contrastive projection module performs channel-wise aggregation and learns from pairs of images that are built using at least one of an augmentation-based pairing strategy, a slice-based pairing strategy, or a combination pairing strategy that incorporates both the augmentation-based pairing strategy and the slice-based pairing strategy.

39. The system of claim 38, wherein the training dataset includes an OCT volume that includes a plurality of OCT B-scans, and wherein the augmentation-based pairing strategy comprises building a positive pair that includes selecting an OCT B-scan from the plurality of OCT B-scans as a first image of the positive pair and augmenting the OCT B-scan to form a second image of the positive pair, wherein augmenting the OCT B-scan includes at least one of horizontal flipping, horizontal translation, vertical translation, zooming in, zooming out, or color distortion.

40. The system of claim 38 or 39, wherein the training dataset includes an OCT volume that includes a plurality of OCT B-scans, and wherein the slice-based pairing strategy comprises building a positive pair that includes selecting a first OCT B-scan from the plurality of OCT B-scans as a first image and selecting a second OCT B-scan from the plurality of OCT B-scans as a second image in which the second OCT B-scan is within a selected distance from the first OCT B-scan.

41. The system of any one of claims 38-40, wherein the combination pairing strategy comprises building a pair of images using the slice-based pairing strategy and augmenting at least one image of the pair of images using the augmentation-based pairing strategy.

42. The system of any one of claims 29-41, wherein forming the image input using the initial imaging data comprises:
performing at least one of a normalization operation, a scaling operation, a resizing operation, a horizontal flipping operation, a vertical flipping operation, a cropping operation, a rotation operation, or a noise filtering operation.

43. The system of any one of claims 29-42, wherein a retinal element of the set of retinal elements comprises at least one of intraretinal fluid (IRF), subretinal fluid (SRF), fluid associated with pigment epithelial detachment (PED), hyperreflective material (HRM), subretinal hyperreflective material (SHRM), intraretinal hyperreflective material (IHRM), hyperreflective foci (HRF), a retinal fluid pocket, or a disruption.

44. The system of any one of claims 29-43, wherein a retinal element of the set of retinal elements is associated with a retinal layer selected from a group consisting of an internal limiting membrane (ILM) layer, an external limiting membrane (ELM) layer, an outer plexiform layer-Henle fiber layer (OPL-HFL), a retinal pigment epithelial (RPE) layer, a layer of RPE detachment, a Bruch's membrane (BM) layer, and an ellipsoid zone (EZ).

45. The system of any one of claims 29-44, wherein the segmentation output comprises a segmentation map that comprises at least one of a color indicator, a shape indicator, a pattern indicator, a shading indicator, a line, a curve, a marker, a label, a tag, or text that graphically locates at least one retinal element of the set of retinal elements.

46. A system for training a machine learning model to perform automated segmentation, the system comprising:
one or more data processors; and
a non-transitory computer readable storage medium containing instructions which, when executed on the one or more data processors, cause the one or more data processors to:
form a training dataset that includes labeled imaging data associated with a set of source domains; and
train the machine learning model to perform the automated segmentation using the training dataset and a loss function that combines a supervised learning loss and a contrastive learning loss,
wherein the trained machine learning model is capable of processing imaging data associated with a target domain to generate a segmentation output with a desired level of performance;
wherein the target domain is different from the set of source domains; and
wherein the training dataset excludes any labeled imaging data associated with the target domain.

47. The system of claim 46, wherein the training dataset further includes unlabeled imaging data associated with the target domain.

48. The system of claim 46 or claim 47, wherein the training dataset further includes unlabeled imaging data associated with at least one source domain of the set of source domains.

49. The system of any one of claims 46-48, wherein the target domain includes imaging data acquired from a different imaging device than imaging data associated with the set of source domains.

50. The system of any one of claims 46-48, wherein the target domain includes imaging data that captures a different retinal disease or condition than imaging data associated with the set of source domains.

51. The system of any one of claims 46-50, wherein machine learning model is a joint learning model that includes a segmentation backbone, an encoder, and a contrastive projection module.

52. The system of claim 51, wherein the segmentation backbone comprises a UNet architecture, wherein the encoder comprises a UNet encoder, and wherein the contrastive projection module performs channel-wise aggregation.

53. The system of any one of claims 46-52, wherein the training dataset includes an OCT volume that comprises a plurality of OCT B-scans and wherein training the machine learning model comprises:
building a plurality of pairs using the training dataset for use in computing the contrastive learning lost using at least one of an augmentation-based pairing strategy, a slice-based pairing strategy, or a combination pairing strategy that incorporates both the augmentation-based pairing strategy and the slice-based pairing strategy.

54. The system of claim 53, wherein the augmentation-based pairing strategy comprises building a positive pair that includes selecting an OCT B-scan from the plurality of OCT B-scans as a first image of the positive pair and augmenting the OCT B-scan to form a second image of the positive pair, wherein augmenting the OCT B-scan includes at least one of horizontal flipping, horizontal translation, vertical translation, zooming in, zooming out, or color distortion.

55. The system of claim 53 or claim 54, wherein the slice-based pairing strategy comprises building a positive pair that includes selecting a first OCT B-scan from the plurality of OCT B-scans as a first image and selecting a second OCT B-scan from the plurality of OCT B-scans as a second image in which the second OCT B-scan is within a selected distance from the first OCT B-scan.

56. The system of any one of claims 53-55, wherein the combination pairing strategy comprises building a pair of images using the slice-based pairing strategy and augmenting at least one image of the pair of images using the augmentation-based pairing strategy.

57. A system comprising:
one or more data processors; and
a non-transitory computer readable storage medium containing instructions which, when executed on the one or more data processors, cause the one or more data processors to perform part or all of one or more methods disclosed in claims 1-28.

58. A computer-program product tangibly embodied in a non-transitory machine-readable storage medium, including instructions configured to cause one or more data processors to perform part or all of one or more methods disclosed in claims 1-28.
